(19) United States
(12) Patent Application Publication
(10) Pub. No.: US 2026/0343017 A1
(43) Pub. Date: Oct. 29, 2026

(54) IMAGE ENCODING/DECODING METHOD AND RECORDING MEDIUM FOR STORING BITSTREAM

(71) Applicant: KT CORPORATION, Gyeonggi-do (KR)

(72) Inventor: Sung Won LIM, Gyeonggi-do (KR)

(73) Assignee: KT CORPORATION, Gyeonggi-do (KR)

(21) Appl. No.: 19/485,665

(22) PCT Filed: Jun. 26, 2024
(86) PCT No.: PCT/KR2024/008916

§ 371 Date: Nov. 18, 2025

(30) Foreign Application Priority Data
Jun. 27, 2023 (KR) 10-2023-0083018
Jun. 25, 2024 (KR) 10-2024-0082641

(51) Int. Cl. H04N 19/577; H04N 19/105; H04N 19/159; H04N 19/176; H04N 19/186; H04N 19/593

(52) U.S. Cl. CPC H04N 19/577; H04N 19/105; H04N 19/159; H04N 19/176; H04N 19/186; H04N 19/593

(57) ABSTRACT

An image decoding method according to the present disclosure may comprise the steps of: deriving a first reference block of a luma block that is in a co-located position of a chroma block; deriving a second reference block of the chroma block; deriving a prediction parameter on the basis of the first reference block and the second reference block; and applying the prediction parameter to the luma block to obtain a prediction block for the chroma block.

### TECHNICAL FIELD

The present disclosure relates to a method and a device for processing a video signal.

### BACKGROUND ART

Recently, demands for high-resolution and high-quality images such as HD (High Definition) images and UHD (Ultra High Definition) images have increased in a variety of application fields. As image data becomes high-resolution and high-quality, the volume of data relatively increases compared to the existing image data, so when image data is transmitted by using media such as the existing wire and wireless broadband circuit or is stored by using the existing storage medium, expenses for transmission and expenses for storage increase. High efficiency image compression technologies may be utilized to resolve these problems which are generated as image data becomes high-resolution and high-quality.

There are various technologies such as an inter prediction technology which predicts a pixel value included in a current picture from a previous or subsequent picture of a current picture with an image impression technology, an intra prediction technology which predicts a pixel value included in a current picture by using pixel information in a current picture, an entropy encoding technology which assigns a short sign to a value with high appearance frequency and assigns a long sign to a value with low appearance frequency and so on, and image data may be effectively compressed and transmitted or stored by using these image compression technologies.

On the other hand, as demands for a high-resolution image have increased, demands for stereo-scopic image contents have increased as a new image service. A video compression technology for effectively providing high-resolution and ultra high-resolution stereo-scopic image contents has been discussed.

### DISCLOSURE

### Technical Problem

The present disclosure is to provide a method for predicting a chroma block through cross color components prediction even when a luma block is encoded by inter prediction and a device for the same.

The present disclosure is to provides a method for deriving a prediction parameter based on a pre-reconstructed luma reference block and chroma reference block and a device for the same.

Technical problems that the present disclosure may be solved are non-limited by the above-mentioned technical problems, and other unmentioned technical effects may be clearly understood from the following description by those having ordinary skill in the technical field to which the present disclosure pertains.

### Technical Solution

An image decoding method according to the present disclosure may include deriving a first reference block of a luma block at a co-located position of a chroma block; deriving a second reference block of the chroma block; deriving a prediction parameter based on the first reference block and the second reference block; and applying the prediction parameter to the luma block to obtain a prediction block for the chroma block.

An image encoding method according to the present disclosure may include deriving a first reference block of a luma block at a co-located position of a chroma block; deriving a second reference block of the chroma block; deriving a prediction parameter based on the first reference block and the second reference block; and applying the prediction parameter to the luma block to obtain a prediction block for the chroma block.

In an image decoding/encoding method according to the present disclosure, when bi-prediction is applied to the luma block, the first reference block may be obtained by weighted sum of an L0 reference block and an L1 reference block of the luma block, and the second reference block may be obtained by weighted sum of an L0 reference block and an L1 reference block of the chroma block.

In an image decoding/encoding method according to the present disclosure, when bi-prediction is applied to the luma block, the first reference block and the second reference block may be determined based on a picture order count (POC) of an L0 reference picture and an L1 reference picture of the luma block.

In an image decoding/encoding method according to the present disclosure, when a distance between the L0 reference picture and a current picture is smaller than a distance between the L1 reference picture and the current picture, each of the first reference block and the second reference block may represent an L0 reference block of the luma block and an L0 reference block of the chroma block, and when a distance between the L1 reference picture and the current picture is smaller than a distance between the L0 reference picture and the current picture, each of the first reference block and the second reference block may represent an L1 reference block of the luma block and an L1 reference block of the chroma block.

In an image decoding/encoding method according to the present disclosure, when a distance between the L0 reference picture and the current picture and a distance between the L1 reference picture and the current picture are the same, the first reference block may be obtained by weighted sum of the L0 reference block and the L1 reference block of the luma block, and the second reference block may be obtained by weighted sum of the L0 reference block and the L1 reference block of the chroma block.

In an image decoding/encoding method according to the present disclosure, when bi-prediction is applied to the luma block, the first reference block and the second reference block may be derived from at least one of a reference picture in an L0 direction or a reference picture in an L1 direction, and at least one of the L0 direction and the L1 direction may be selected based on prediction direction information decoded from a bitstream.

In an image decoding/encoding method according to the present disclosure, the prediction parameter may include a weight and an offset.

In an image decoding/encoding method according to the present disclosure, a prediction sample of the chroma block may be derived by adding the offset to a result obtained by multiplying a reconstructed sample, corresponding to a position of the prediction sample, in the luma block by the weight.

In an image decoding/encoding method according to the present disclosure, the prediction parameter may include filter coefficients for a convolution filter.

In an image decoding/encoding method according to the present disclosure, a prediction sample of the chroma block may be derived by inputting a reconstructed sample, corresponding to a position of the prediction sample, in the luma block and at least one neighboring sample adjacent to the reconstructed sample into the convolution filter.

In an image decoding/encoding method according to the present disclosure, a type of the prediction parameter is determined as one of a plurality of prediction parameter type candidates, and the plurality of prediction parameter type candidates may include a first prediction parameter candidate including a weight and an offset and a second prediction parameter candidate including filter coefficients of a convolution filter.

In an image decoding/encoding method according to the present disclosure, when an intra block copy mode is applied to the luma block, the first reference block may be derived from a current luma picture including the luma block, and the second reference block may be derived from a current chroma picture including the chroma block.

In an image decoding/encoding method according to the present disclosure, the prediction parameter may be derived in a sub-block unit within the chroma block.

According to the present disclosure, a computer-readable recording medium for storing a bitstream generated by the image encoding method may be provided.

The features briefly summarized above for the present disclosure are just an exemplary aspect of a detailed description for the present disclosure described below, and do not limit the scope of the present disclosure.

### Technical Effect

According to the present disclosure, even when a luma block is encoded by inter prediction, prediction accuracy may be improved by performing cross color components prediction.

According to the present disclosure, signaling overhead may be reduced by deriving a prediction parameter based on a pre-reconstructed luma reference block and chroma reference block.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a block diagram showing an image encoding device according to an embodiment of the present disclosure.

FIG. 2 is a block diagram showing an image decoding device according to an embodiment of the present disclosure.

FIG. 3 is a diagram schematically representing the process of performing inter prediction in an encoder and a decoder.

FIG. 4 shows an example in which motion estimation is performed.

FIGS. 5 and 6 show an example in which a prediction block of a current block is generated based on motion information generated through motion estimation.

FIG. 7 shows a position referred to for deriving a motion vector prediction value.

FIG. 8 is a diagram for describing a template-based motion estimation method.

FIG. 9 shows examples in which a template is configured.

FIG. 10 is a diagram for describing a motion estimation method based on a bilateral matching method.

FIG. 11 is a diagram for describing a motion estimation method based on a unilateral matching method.

FIGS. 12 and 13 illustrate an example in which a prediction block is generated according to the precision of a motion vector.

FIG. 14 represents an example in which motion compensation based on a translation model and a zooming model is performed for a current block.

FIG. 15 represents an example in which motion compensation based on a translation model and a rotation model is performed for a current block.

FIGS. 16 and 17 represent an example in which a prediction block for a current block is generated by using control point motion vectors.

FIG. 18 represents an example in which a prediction block for a current block is generated by using three control point motion vectors.

FIG. 19 represents an example in which a motion vector is derived in a sub-block unit.

FIGS. 20 and 21 represent an example in which a motion vector is derived in a sub-block unit within a current block when SbTMVP is applied.

FIGS. 22 and 23 are a diagram representing an example in which a prediction block is derived according to motion vector precision.

FIGS. 24 and 25 are a diagram for describing the process of encoding and decoding a motion vector difference value when an AMVR method is applied, respectively.

FIG. 26 represents the flowchart of a prediction method cross color components based on a prediction parameter.

FIGS. 27 and 28 represent the operation of an decoder/a decoder according to a prediction method between color components based on a prediction parameter.

FIG. 29 illustrates an example in which a chroma block is predicted by selecting one of a plurality of prediction parameter candidates.

FIG. 30 represents an example in which a prediction parameter for a chroma component is derived.

FIG. 31 represents a subsampled position.

FIG. 32 represents an example in which a prediction parameter is derived by using a convolution filter.

FIG. 33 represents the shape of a convolution filter.

FIG. 34 is a diagram for describing an example in which a prediction method between color components based on a prediction parameter is performed in a sub-block unit.

### MODE FOR INVENTION

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference numeral was used for a similar component while describing each drawing.

A term such as first, second, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term of and/or includes a combination of a plurality of relative entered items or any item of a plurality of relative entered items.

When a component is referred to as being “linked” or “connected” to other component, it should be understood that it may be directly linked or connected to that other component, but other component may exist in the middle. On the other hand, when a component is referred to as being “directly linked” or “directly connected” to other component, it should be understood that other component does not exist in the middle.

As terms used in this application are just used to describe a specific embodiment, they are not intended to limit the present disclosure. Expression of the singular includes expression of the plural unless it clearly has a different meaning contextually. In this application, it should be understood that a term such as “include” or “have”, etc. is to designate the existence of characteristics, numbers, steps, motions, components, parts or their combinations entered in the specification, but is not to exclude a possibility of addition or existence of one or more other characteristics, numbers, steps, motions, components, parts or their combinations in advance.

Hereinafter, referring to the attached drawings, a desirable embodiment of the present disclosure will be described in more detail. Hereinafter, the same reference numeral is used for the same component in a drawing and an overlapping description for the same component is omitted.

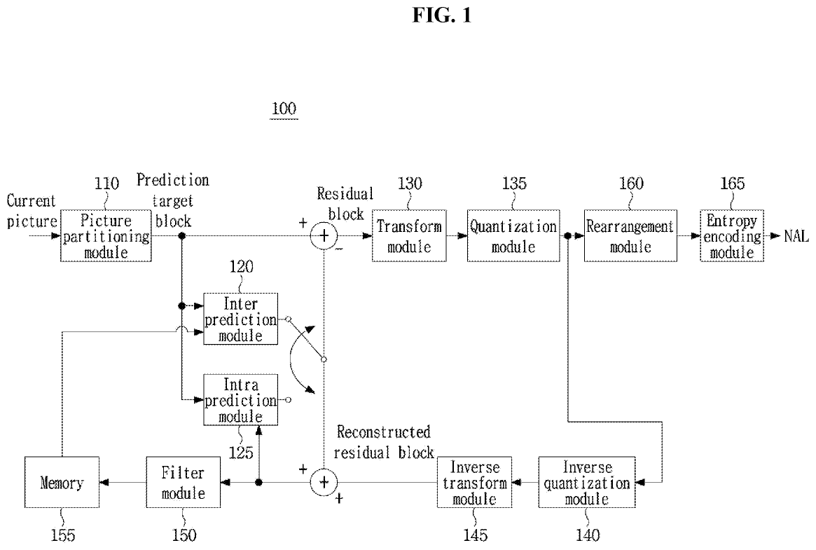

FIG. 1 is a block diagram showing an image encoding device according to an embodiment of the present disclosure.

Referring to FIG. 1, an image encoding device 100 may include a picture partitioning unit 110, prediction units 120 and 125, a transform unit 130, a quantization unit 135, a rearrangement unit 160, an entropy encoding unit 165, a dequantization unit 140, an inverse-transform unit 145, a filter unit 150, and a memory 155.

As each construction unit shown in FIG. 1 is independently shown to represent different characteristic functions in an image encoding device, it does not mean that each construction unit is constituted by separated hardware or one software unit. That is, as each construction unit is included by being enumerated as each construction unit for convenience of a description, at least two construction units of each construction unit may be combined to constitute one construction unit or one construction unit may be partitioned into a plurality of construction units to perform a function, and even an integrated embodiment and a separated embodiment of each construction unit are also included in a scope of a right of the present disclosure unless they are departing from the essence of the present disclosure.

Further, some components may be just an optional component for improving performance, not a necessary component which perform an essential function in the present disclosure. The present disclosure may be implemented by including only a construction unit necessary for implementing the essence of the present disclosure excluding a component used to just improve performance, and a structure including only a necessary component excluding an optional component used to just improve performance is also included in a scope of a right of the present disclosure.

A picture partitioning unit 110 may partition an input picture into at least one processing unit. In this case, a processing unit may be a prediction unit (PU), a transform unit (TU) or a coding unit (CU). In a picture partitioning unit 110, one picture may be partitioned into a combination of a plurality of coding units, prediction units and transform units and a picture may be encoded by selecting a combination of one coding unit, prediction unit and transform unit according to a predetermined standard (e.g., a cost function).

For example, one picture may be partitioned into a plurality of coding units. In order to partition a coding unit in a picture, a recursive tree structure such as a quad tree, a ternary tree, or a binary tree may be used, and a coding unit which is partitioned into other coding units by using one image or the largest coding unit as a route may be partitioned with as many child nodes as the number of partitioned coding units. A coding unit which is no longer partitioned according to a certain restriction becomes a leaf node. As an example, when it is assumed that quad tree partitioning is applied to one coding unit, one coding unit may be partitioned into up to four other coding units.

Hereinafter, in an embodiment of the present disclosure, a coding unit may be used as a unit for encoding or may be used as a unit for decoding.

A prediction unit may be partitioned with at least one square or rectangular shape, etc. in the same size in one coding unit or may be partitioned so that any one prediction unit of prediction units partitioned in one coding unit can have a shape and/or a size different from another prediction unit.

In intra prediction, a transform unit may be set to be the same as a prediction unit. In this case, after a coding unit is partitioned into a plurality of transform units, intra prediction may be performed per each transform unit. A coding unit may be partitioned in a horizontal direction or in a vertical direction. The number of transform units generated by partitioning a coding unit may be 2 or 4 according to a size of a coding unit.

Prediction units 120 and 125 may include an inter prediction unit 120 performing inter prediction and an intra prediction unit 125 performing intra prediction. Whether to perform inter prediction or intra prediction for a coding unit may be determined and detailed information according to each prediction method (e.g., an intra prediction mode, a motion vector, a reference picture, etc.) may be determined. In this case, a processing unit that prediction is performed may be different from a processing unit that a prediction method and details are determined. For example, a prediction method, a prediction mode, etc. may be determined in a coding unit and prediction may be performed in a prediction unit or in a transform unit. A residual value (a residual block) between a generated prediction block and an original block may be input to a transform unit 130. In addition, prediction mode information, motion vector information, etc. used for prediction may be encoded with a residual value in an entropy encoding unit 165 and may be transmitted to a decoding device. When a specific encoding mode is used, an original block may be encoded as it is and transmitted to a decoding unit without generating a prediction block through prediction units 120 or 125.

An inter prediction unit 120 may predict a prediction unit based on information on at least one picture of a previous picture or a subsequent picture of a current picture, or in some cases, may predict a prediction unit based on information on some encoded regions in a current picture. An inter prediction unit 120 may include a reference picture interpolation unit, a motion prediction unit and a motion compensation unit.

A reference picture interpolation unit may receive reference picture information from a memory 155 and generate pixel information equal to or less than an integer pixel in a reference picture. For a luma pixel, a 8-tap DCT-based interpolation filter having a different filter coefficient may be used to generate pixel information equal to or less than an integer pixel in a 1/4 pixel unit. For a chroma signal, a 4-tap DCT-based interpolation filter having a different filter coefficient may be used to generate pixel information equal to or less than an integer pixel in a 1/8 pixel unit.

A motion prediction unit may perform motion prediction based on a reference picture interpolated by a reference picture interpolation unit. As a method for calculating a motion vector, various methods such as FBMA (Full search-based Block Matching Algorithm), TSS (Three Step Search), NTS (New Three-Step Search Algorithm), etc. may be used. A motion vector may have a motion vector value in a 1/2 or 1/4 pixel unit based on an interpolated pixel. A motion prediction unit may predict a current prediction unit by varying a motion prediction method. As a motion prediction method, various methods such as a skip method, a merge method, an advanced motion vector prediction (AMVP) method, an intra block copy method, etc. may be used.

An intra prediction unit 125 may generate a prediction unit based on reference pixel information that is pixel information in a current picture. Reference pixel information may be derived from one selected among a plurality of reference pixel lines. A N-th reference pixel line among a plurality of reference pixel lines may include left pixels where an x-axis difference with a top-left pixel within a current block is N and top pixels where an y-axis difference with the top-left pixel is N. The number of reference pixel lines that may be selected by a current block may be 1,2,3, or 4.

When a neighboring block in a current prediction unit is a block which performed inter prediction and accordingly, a reference pixel is a pixel which performed inter prediction, a reference pixel included in a block which performed inter prediction may be used by being replaced with reference pixel information of a neighboring block which performed intra prediction. In other words, when a reference pixel is unavailable, unavailable reference pixel information may be used by being replaced with at least one information among the available reference pixels.

A prediction mode in intra prediction may have a directional prediction mode using reference pixel information according to a prediction direction and a non-directional mode not using directional information when performing prediction. A mode for predicting luma information may be different from a mode for predicting chroma information and intra prediction mode information used for predicting luma information or predicted luma signal information may be utilized to predict chroma information.

When a size of a prediction unit is the same as that of a transform unit in performing intra prediction, intra prediction for a prediction unit may be performed based on a pixel at a left position of a prediction unit, a pixel at a top-left position and a pixel at a top position.

An intra prediction method may generate a prediction block after applying a smoothing filter to a reference pixel according to a prediction mode. According to a selected reference pixel line, whether to apply a smoothing filter may be determined.

In order to perform an intra prediction method, an intra prediction mode in a current prediction unit may be predicted from an intra prediction mode in a prediction unit around a current prediction unit. When a prediction mode in a current prediction unit is predicted by using mode information predicted from a surrounding prediction unit, information that a prediction mode in a current prediction unit is the same as a prediction mode in a surrounding prediction unit may be transmitted by using predetermined flag information if an intra prediction mode in a current prediction unit is the same as an intra prediction mode in a surrounding prediction unit, and prediction mode information of a current block may be encoded by performing entropy encoding if a prediction mode in a current prediction unit is different from a prediction mode in a surrounding prediction unit.

In addition, a residual block may be generated which includes information on a residual value that is a difference value between a prediction unit which performed prediction based on a prediction unit generated in prediction units 120 and 125 and an original block in a prediction unit. A generated residual block may be input to a transform unit 130.

A transform unit 130 may transform an original block and a residual block including residual value information in a prediction unit generated through prediction units 120 and 125 by using a transform method such as DCT (Discrete Cosine Transform), DST (Discrete Sine Transform), KLT. Whether to apply DCT, DST or KLT to transform a residual block may be determined based on at least one of a size of a transform unit, a form of a transform unit, a prediction mode in a prediction unit or intra prediction mode information in a prediction unit.

A quantization unit 135 may quantize values transformed into a frequency domain in a transform unit 130. A quantization coefficient may be changed according to a block or importance of an image. A value calculated in a quantization unit 135 may be provided to a dequantization unit 140 and a rearrangement unit 160.

A rearrangement unit 160 may perform rearrangement of a coefficient value for a quantized residual value.

A rearrangement unit 160 may change a coefficient in a shape of a two-dimensional block into a shape of a one-dimensional vector through a coefficient scan method. For example, a rearrangement unit 160 may scan a DC coefficient to a coefficient in a high-frequency domain by using a zig-zag scan method and change it into a shape of a one-dimensional vector. According to a size of a transform unit and an intra prediction mode, instead of zig-zag scan, vertical scan where a coefficient in a shape of a two-dimensional block is scanned in a column direction, horizontal scan where a coefficient in a shape of a two-dimensional block is scanned in a row direction, or diagonal scan where a coefficient in a shape of a two-dimensional block is scanned in a diagonal direction may be used. In other words, which scan method among zig-zag scan, vertical directional scan, horizontal directional scan or diagonal scan will be used may be determined according to a size of a transform unit and an intra prediction mode.

An entropy encoding unit 165 may perform entropy encoding based on values calculated by a rearrangement unit 160. Entropy encoding, for example, may use various encoding methods such as exponential Golomb, CAVLC (Context-Adaptive Variable Length Coding), CABAC (Context-Adaptive Binary Arithmetic Coding).

An entropy encoding unit 165 may encode a variety of information such as residual value coefficient information and block type information in a coding unit, prediction mode information, partitioning unit information, prediction unit information and transmission unit information, motion vector information, reference frame information, block interpolation information, filtering information, etc. from a rearrangement unit 160 and prediction units 120 and 125.

An entropy encoding unit 165 may perform entropy encoding for a coefficient value in a coding unit which is input from a rearrangement unit 160.

A dequantization unit 140 and an inverse transform unit 145 dequantize values quantized in a quantization unit 135 and inversely transform values transformed in a transform unit 130. A residual value generated by a dequantization unit 140 and an inverse transform unit 145 may be combined with a prediction unit predicted by a motion prediction unit, a motion compensation unit and an intra prediction unit included in prediction units 120 and 125 to generate a reconstructed block.

A filter unit 150 may include at least one of a deblocking filter, an offset correction unit and an adaptive loop filter (ALF).

A deblocking filter may remove block distortion which is generated by a boundary between blocks in a reconstructed picture. In order to determine whether deblocking is performed, whether a deblocking filter will be applied to a current block may be determined based on a pixel included in several rows or columns included in a block. When a deblocking filter is applied to a block, a strong filter or a weak filter may be applied according to required deblocking filtering strength. In addition, in applying a deblocking filter, when horizontal filtering and vertical filtering are performed, horizontal directional filtering and vertical directional filtering may be set to be processed in parallel.

An offset correction unit may correct an offset with an original image in a unit of a pixel for an image that deblocking was performed. In order to perform offset correction for a specific picture, a region where an offset will be performed may be determined after dividing a pixel included in an image into the certain number of regions and a method in which an offset is applied to a corresponding region or a method in which an offset is applied by considering edge information of each pixel may be used.

Adaptive loop filtering (ALF) may be performed based on a value obtained by comparing a filtered reconstructed image with an original image. After a pixel included in an image is divided into predetermined groups, filtering may be discriminately performed per group by determining one filter which will be applied to a corresponding group. Information related to whether to apply ALF may be transmitted per coding unit (CU) for a luma signal and a shape and a filter coefficient of an ALF filter to be applied may vary according to each block. In addition, an ALF filter in the same shape (fixed shape) may be applied regardless of a characteristic of a block to be applied.

A memory 155 may store a reconstructed block or picture calculated through a filter unit 150 and a stored reconstructed block or picture may be provided to prediction units 120 and 125 when performing inter prediction.

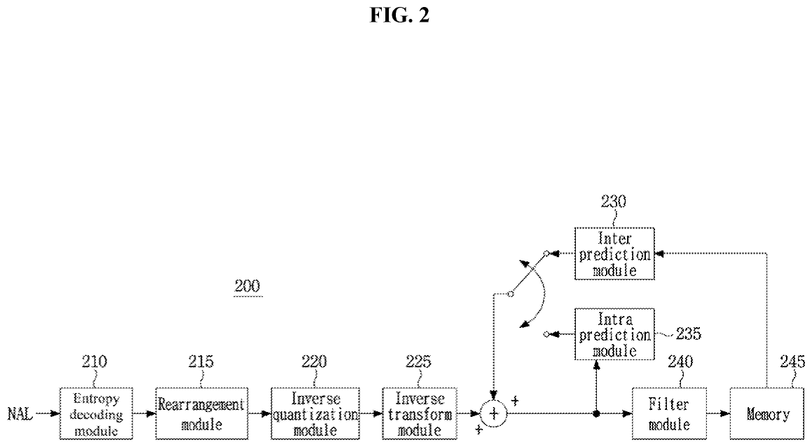

FIG. 2 is a block diagram showing an image decoding device according to an embodiment of the present disclosure.

Referring to FIG. 2, an image decoding device 200 may include an entropy decoding unit 210, a rearrangement unit 215, a dequantization unit 220, an inverse transform unit 225, prediction units 230 and 235, a filter unit 240, and a memory 245.

When an image bitstream is input from an image encoding device, an input bitstream may be decoded according to a procedure opposite to that of an image encoding device.

An entropy decoding unit 210 may perform entropy decoding according to a procedure opposite to a procedure in which entropy encoding is performed in an entropy encoding unit of an image encoding device. For example, in response to a method performed in an image encoding device, various methods such as Exponential Golomb, CAVLC (Context-Adaptive Variable Length Coding), CABAC (Context-Adaptive Binary Arithmetic Coding) may be applied.

An entropy decoding unit 210 may decode information related to intra prediction and inter prediction performed in an encoding device.

A rearrangement unit 215 may perform rearrangement based on a method that a bitstream entropy-decoded in an entropy decoding unit 210 is rearranged in an encoding unit. Coefficients expressed in a form of a one-dimensional vector may be rearranged by being reconstructed into coefficients in a form of a two-dimensional block. A rearrangement unit 215 may receive information related to coefficient scanning performed in an encoding unit and perform rearrangement through a method in which scanning is inversely performed based on scanning order performed in a corresponding encoding unit.

A dequantization unit 220 may perform dequantization based on a quantization parameter provided from an encoding device and a coefficient value of a rearranged block.

An inverse transform unit 225 may perform transform performed in a transform unit, i.e., inverse transform for DCT, DST, and KLT, i.e., inverse DCT, inverse DST and inverse KLT for a result of quantization performed in an image encoding device. Inverse transform may be performed based on a transmission unit determined in an image encoding device. In an inverse transform unit 225 of an image decoding device, a transform technique (for example, DCT, DST, KLT) may be selectively performed according to a plurality of information such as a prediction method, a size or a shape of a current block, a prediction mode, an intra prediction direction, etc.

Prediction units 230 and 235 may generate a prediction block based on information related to generation of a prediction block provided from an entropy decoding unit 210 and pre-decoded block or picture information provided from a memory 245.

As described above, when a size of a prediction unit is the same as a size of a transform unit in performing intra prediction in the same manner as an operation in an image encoding device, intra prediction for a prediction unit may be performed based on a pixel at a left position of a prediction unit, a pixel at a top-left position and a pixel at a top position, but when a size of a prediction unit is different from a size of a transform unit in performing intra prediction, intra prediction may be performed by using a reference pixel based on a transform unit. In addition, intra prediction using N×N partitioning may be used only for the smallest coding unit.

Prediction units 230 and 235 may include a prediction unit determination unit, an inter prediction unit and an intra prediction unit. A prediction unit determination unit may receive a variety of information such as prediction unit information, prediction mode information of an intra prediction method, motion prediction-related information of an inter prediction method, etc. which are input from an entropy decoding unit 210, divide a prediction unit in a current coding unit and determine whether a prediction unit performs inter prediction or intra prediction. An inter prediction unit 230 may perform inter prediction for a current prediction unit based on information included in at least one picture of a previous picture or a subsequent picture of a current picture including a current prediction unit by using information necessary for inter prediction in a current prediction unit provided from an image encoding device. Alternatively, inter prediction may be performed based on information on some regions which are pre-reconstructed in a current picture including a current prediction unit.

In order to perform inter prediction, whether a motion prediction method in a prediction unit included in a corresponding coding unit is a skip mode, a merge mode, an AMVP mode, or an intra block copy mode may be determined based on a coding unit.

An intra prediction unit 235 may generate a prediction block based on pixel information in a current picture. When a prediction unit is a prediction unit which performed intra prediction, intra prediction may be performed based on intra prediction mode information in a prediction unit provided from an image encoding device. An intra prediction unit 235 may include an adaptive intra smoothing (AIS) filter, a reference pixel interpolation unit and a DC filter. As a part performing filtering on a reference pixel of a current block, an AIS filter may be applied by determining whether a filter is applied according to a prediction mode in a current prediction unit. AIS filtering may be performed for a reference pixel of a current block by using AIS filter information and a prediction mode in a prediction unit provided from an image encoding device. When a prediction mode of a current block is a mode which does not perform AIS filtering, an AIS filter may not be applied.

When a prediction mode in a prediction unit is a prediction unit which performs intra prediction based on a pixel value which interpolated a reference pixel, a reference pixel interpolation unit may interpolate a reference pixel to generate a reference pixel in a unit of a pixel equal to or less than an integer value. When a prediction mode in a current prediction unit is a prediction mode which generates a prediction block without interpolating a reference pixel, a reference pixel may not be interpolated. A DC filter may generate a prediction block through filtering when a prediction mode of a current block is a DC mode.

A reconstructed block or picture may be provided to a filter unit 240. A filter unit 240 may include a deblocking filter, an offset correction unit and an ALF.

Information on whether a deblocking filter was applied to a corresponding block or picture and information on whether a strong filter or a weak filter was applied when a deblocking filter was applied may be provided from an image encoding device. Information related to a deblocking filter provided from an image encoding device may be provided in a deblocking filter of an image decoding device and deblocking filtering for a corresponding block may be performed in an image decoding device.

An offset correction unit may perform offset correction on a reconstructed image based on offset value information, a type of offset correction, etc. applied to an image when performing encoding.

An ALF may be applied to a coding unit based on information on whether ALF is applied, ALF coefficient information, etc. provided from an encoding device. Such ALF information may be provided by being included in a specific parameter set.

A memory 245 may store a reconstructed picture or block for use as a reference picture or a reference block and provide a reconstructed picture to an output unit.

As described above, hereinafter, in an embodiment of the present disclosure, a coding unit is used as a term of a coding unit for convenience of a description, but it may be a unit which performs decoding as well as encoding.

In addition, as a current block represents a block to be encoded/decoded, it may represent a coding tree block (or a coding tree unit), a coding block (or a coding unit), a transform block (or a transform unit), a prediction block (or a prediction unit), a block to which an in-loop filter is applied, etc. according to an encoding/decoding step. In this specification, ‘unit’ may represent a base unit for performing a specific encoding/decoding process and ‘block’ may represent a pixel array in a predetermined size. Unless otherwise classified, ‘block’ and ‘unit’ may be used interchangeably. For example, in the after-described embodiment, it may be understood that a coding block (a coding block) and a coding unit (a coding unit) are used interchangeably.

Furthermore, a picture in which a current block is included is called a current picture.

When encoding a current picture, redundant data between pictures may be removed through inter prediction. Inter prediction may be performed in a unit of a block. Specifically, the motion information of a current block may be used to generate a prediction block of a current block from a reference picture. Here, motion information may include at least one of a motion vector, a reference picture index, and a prediction direction.

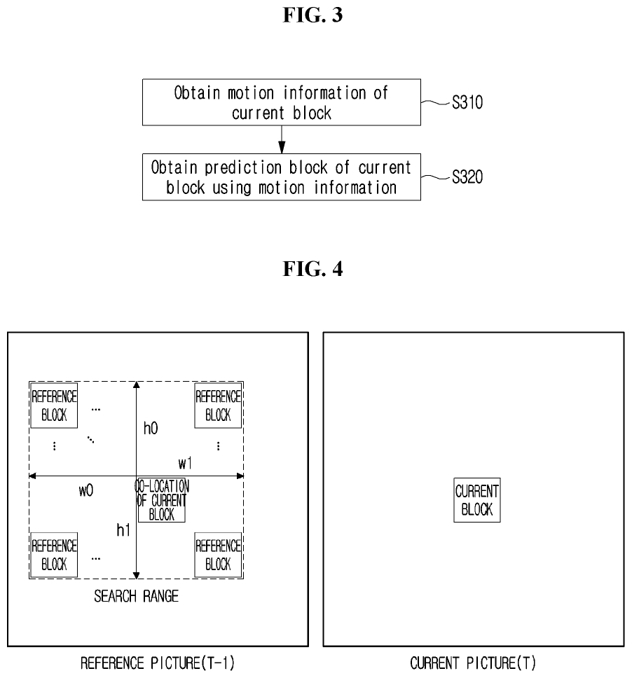

FIG. 3 is a diagram schematically representing the process of performing inter prediction in an encoder and a decoder.

As in an example illustrated in FIG. 3, motion information for a current block may be obtained to perform inter prediction S310. Here, motion information may include at least one of a motion vector, a reference picture index or a weight applied to a prediction block. For a current block, motion information for at least one of an L0 direction or an L1 direction may be obtained.

An encoder may derive the motion information of a current block through motion estimation, encode derived motion information and signal it to a decoder. Meanwhile, encoding/decoding of motion information may be based on a motion information merge mode, a motion vector prediction mode, a template-based motion estimation method or a bilateral matching method which will be described later.

A decoder may derive the motion information of a current block based on information transmitted from an encoder.

Alternatively, a decoder may derive the motion information of a current block in the same method as in an encoder. This method may be called decoder-side motion estimation.

When the motion information of a current block is denved, a prediction block for a current block may be obtained based on derived motion information S320. As an example, a reference block spaced apart by a motion vector from the position of a current block within a reference picture may be set as the prediction block of a current block.

Hereinafter, the process of performing inter prediction is described in more detail.

The motion information of a current block may be generated through motion estimation.

FIG. 4 shows an example in which motion estimation is performed.

In FIG. 4, it is assumed that the Picture Order Count (POC) of a current picture is T and the POC of a reference picture is (T−1).

A search range for motion estimation may be set from the same position as a reference point of a current block in a reference picture. Here, a reference point may be a position of a top-left sample of a current block.

As an example, in FIG. 4, it was illustrated that a square in a size of (w0+w01) and (h0+h1) is set to be within a search range centered on a reference point. In an example above, w0, w1, h0 and h1 may have the same value. Alternatively, at least one of w0, w1, h0 and h1 may be set to have a different value from the other. Alternatively, a size of w0, w1, h0 and h1 may be determined not to exceed a Coding Tree Unit (CTU) boundary, a slice boundary, a tile boundary or a picture boundary.

Within a search range, after reference blocks having the same size as a current block are set, a cost with a current block may be measured for each reference block. A cost may be calculated by using a similarity between two blocks.

As an example, a cost may be calculated based on the sum of absolute differences (SAD) between original samples in a current block and original samples (or reconstructed samples) in a reference block. As a SAD is smaller, a cost may be reduced.

Afterwards, a reference block with an optimal cost may be set as a prediction block of a current block by comparing a cost of each reference block.

Then, a distance between a current block and a reference block may be set as a motion vector. Specifically, an x-coordinate difference and a y-coordinate difference between a current block and a reference block may be set as a motion vector.

Furthermore, an index of a picture including a reference block specified through motion estimation is set as a reference picture index.

In addition, a prediction direction may be set based on whether a reference picture belongs to an L0 reference picture list or an L1 reference picture list.

In addition, motion estimation may be performed for each of an L0 direction and an L1 direction. When prediction is performed for both an L0 direction and an L1 direction, motion information in an L0 direction and motion information in an L1 direction may be generated, respectively.

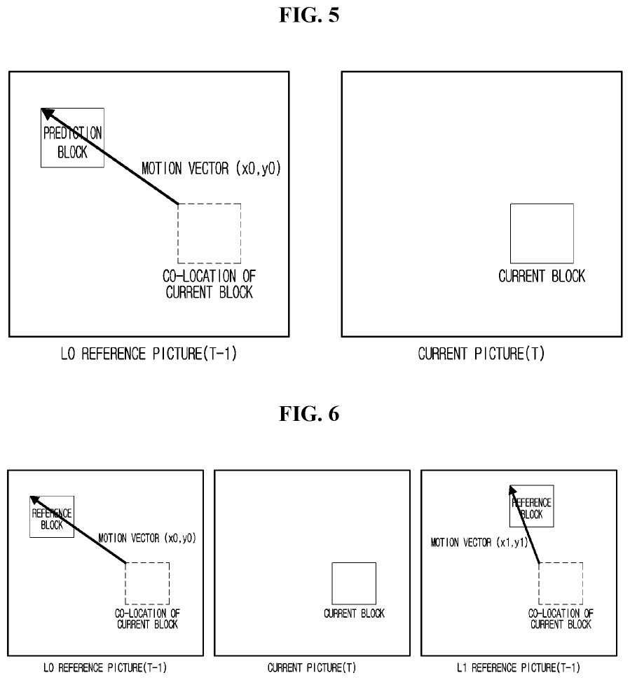

FIGS. 5 and 6 show an example in which a prediction block of a current block is generated based on motion information generated through motion estimation.

FIG. 5 shows an example in which a prediction block is generated by unidirectional (i.e., L0 direction) prediction, and FIG. 6 shows an example in which a prediction block is generated by bidirectional (i.e., L0 and L1 directions) prediction.

For unidirectional prediction, a prediction block of a current block is generated by using one motion information. As an example, motion information may include an L0 motion vector, an L0 reference picture index and prediction direction information indicating an L0 direction.

For bidirectional prediction, a prediction block is generated by using two motion information. As an example, a reference block in an L0 direction specified based on motion information for an L0 direction (L0 motion information) may be set as an L0 prediction block, and a reference block in an L1 direction specified based on motion information for an L1 direction (L1 motion information) may be generated as an L1 prediction block. Afterwards, an L0 prediction block and an L1 prediction block may be weighted to generate a prediction block of a current block.

In an example shown in FIGS. 4 to 6, it was illustrated an L0 reference picture exists in a previous direction of a current picture (i.e., a POC value is smaller than that of a current picture) and an L1 reference picture exists in a subsequent direction of a current picture (i.e., a POC value is greater than that of a current picture).

However, unlike a shown example, an L0 reference picture may exist in a subsequent direction of a current picture, or an L1 reference picture may exist in a previous direction of a current picture. As an example, both an L0 reference picture and an L1 reference picture may exist in a previous direction of a current picture, or may exist in a subsequent direction of a current picture. Alternatively, bidirectional prediction may be performed by using an L0 reference picture existing in a subsequent direction of a current picture and an L1 reference picture existing in a previous direction of a current picture.

The motion information of a block where inter prediction is performed may be stored in a memory. In this case, motion information may be stored in a unit of a sample. Specifically, the motion information of a block to which a specific sample belongs may be stored as the motion information of a specific sample. Stored motion information may be used to derive the motion information of a neighboring block to be decoded/decoded later.

In an encoder, information obtained by encoding a residual sample corresponding to a difference value between a sample of a current block (i.e., an original sample) and a prediction sample and motion information necessary for generating a prediction block may be signaled to a decoder. In a decoder, information about a signaled difference value may be decoded to derive a residual sample, and a reconstructed sample may be generated by adding a prediction sample in a prediction block generated by using motion information to the residual sample.

In this case, in order to effectively compress motion information signaled to a decoder, one of a plurality of inter prediction modes may be selected. Here, a plurality of inter prediction modes may include a motion information merge mode and a motion vector prediction mode.

A motion vector prediction mode is a mode that encodes and signals a difference value between a motion vector and a motion vector prediction value. Here, a motion vector prediction value may be derived based on motion information of a neighboring sample or a neighboring block adjacent to a current block.

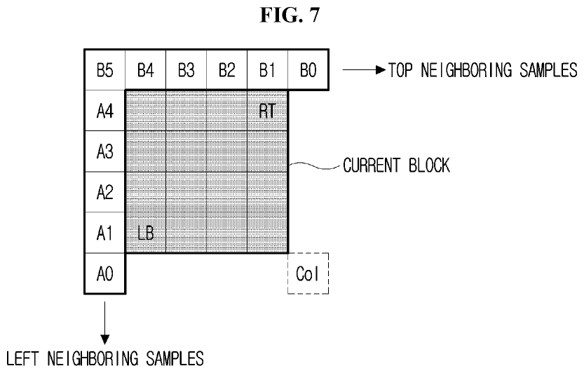

FIG. 7 shows a position referred to for deriving a motion vector prediction value.

For convenience of a description, it is assumed that a current block has a size of 4×4.

In a shown example, ‘LB’ represents a sample included in the leftmost column and the bottommost row in a current block. ‘RT’ represents a sample included in the rightmost column and the topmost row in a current block. A0 to A4 represent samples neighboring the left of a current block, and B0 to B5 represent samples neighboring the top of a current block. As an example, A1 represents a sample neighboring the left of LB, and B1 represents a sample neighboring the top of RT.

Col represents a position of a sample neighboring the bottom-right of a current block in a co-located picture. A collocated picture is a picture different from a current picture, and information (e.g., collocated picture index) for specifying a collocated picture may be explicitly encoded and signaled in a bitstream. Alternatively, a reference picture having a predefined reference picture index may be set as a collocated picture.

A motion vector prediction value of a current block may be derived from at least one motion vector prediction candidate included in a motion vector prediction list.

The number of motion vector prediction candidates that may be inserted into a motion vector prediction list (i.e., a size of a list) may be predefined in an encoder and a decoder. As an example, the maximum number of motion vector prediction candidates may be 2.

A motion vector stored in a position of a neighboring sample adjacent to a current block or a scaled motion vector derived by scaling the motion vector may be inserted into a motion vector prediction list as a motion vector prediction candidate. In this case, neighboring samples adjacent to a current block may be scanned in predefined order to derive a motion vector prediction candidate.

As an example, whether a motion vector is stored at each position in the order of A0 to A4 may be checked. And, according to the scan order, an available motion vector found first may be inserted into a motion vector prediction list as a motion vector prediction candidate.

As another example, whether a motion vector is stored at each position in the order of A0 to A4 is checked, and a motion vector at a position with the same reference picture as a current block that is found first may be inserted into a motion vector prediction list as a motion vector prediction candidate. If there is no neighboring sample that has the same reference picture as a current block, a motion vector prediction candidate may be derived based on an available vector found first. Specifically, after scaling an available motion vector found first, a scaled motion vector may be inserted into a motion vector prediction list as a motion vector prediction candidate. In this case, scaling may be performed based on an output order difference between a current picture and a reference picture (i.e., a POC difference) and an output order difference between a current picture and a reference picture of a neighboring sample (i.e., a POC difference).

Furthermore, in the order of B0 to B5, whether a motion vector is stored at each position may be checked. And, according to the scan order, an available motion vector found first may be inserted into a motion vector prediction list as a motion vector prediction candidate.

As another example, whether a motion vector is stored at each position in the order of B0 to B5 is checked, and a motion vector at a position with the same reference picture as a current block that is found first may be inserted into a motion vector prediction list as a motion vector prediction candidate. If there is no neighboring sample that has the same reference picture as a current block, a motion vector prediction candidate may be derived based on an available vector found first. Specifically, after scaling an available motion vector found first, a scaled motion vector may be inserted into a motion vector prediction list as a motion vector prediction candidate. In this case, scaling may be performed based on an output order difference between a current picture and a reference picture (i.e., a POC difference) and an output order difference between a current picture and a reference picture of a neighboring sample (i.e., a POC difference).

As in an example described above, a motion vector prediction candidate may be derived from a sample adjacent to the left of a current block, and a motion vector prediction candidate may be derived from a sample adjacent to the top of a current block.

In this case, a motion vector prediction candidate derived from a left sample may be inserted into a motion vector prediction list before a motion vector prediction candidate derived from a top sample. In this case, an index allocated to a motion vector prediction candidate derived from a left sample may have a smaller value than a motion vector prediction candidate derived from a top sample.

Conversely, a motion vector prediction candidate derived from a top sample may be inserted into a motion vector prediction list before a motion vector prediction candidate derived from a left sample.

Among the motion vector prediction candidates included in the motion vector prediction list, a motion vector prediction candidate with the highest encoding efficiency may be set as a motion vector predictor (MVP) of a current block. And, index information indicating a motion vector prediction candidate set as a motion vector prediction value of a current block among a plurality of motion vector prediction candidates may be encoded and signaled to a decoder. When the number of motion vector prediction candidates is 2, the index information may be a 1-bit flag (e.g., an MVP flag). In addition, a motion vector difference (MVD), which is a difference between a motion vector of a current block and a motion vector predictor, may be encoded and signaled to a decoder.

A decoder may construct a motion vector prediction list in the same manner as an encoder. In addition, index information may be decoded from a bitstream, and one of a plurality of motion vector prediction candidates may be selected based on decoded index information. A selected motion vector prediction candidate may be set as a motion vector prediction value of a current block.

In addition, a motion vector difference value may be decoded from a bitstream. Afterwards, a motion vector of a current block may be derived by combining a motion vector prediction value and a motion vector difference value.

When bidirectional prediction is applied to a current block, a motion vector prediction list may be generated for each of an L0 direction and an L1 direction. In other words, a motion vector prediction list may be composed of motion vectors in the same direction. Accordingly, a motion vector of a current block and motion vector prediction candidates included in a motion vector prediction list have the same direction.

When a motion vector prediction mode is selected, a reference picture index and prediction direction information may be explicitly encoded and signaled to a decoder. As an example, when there are a plurality of reference pictures on a reference picture list and motion estimation is performed for each of a plurality of reference pictures, a reference picture index for specifying a reference picture where motion information of a current block is derived among the plurality of reference pictures may be explicitly encoded and signaled to a decoder.

In this case, when only one reference picture is included in a reference picture list, the encoding/decoding of the reference picture index may be omitted.

Prediction direction information may be an index indicating one of L0 unidirectional prediction, L1 unidirectional prediction, or bidirectional prediction. Alternatively, an L0 flag representing whether prediction for an L0 direction is performed and an L1 flag representing whether prediction for an L1 direction is performed may be encoded and signaled, respectively.

A motion information merge mode is a mode that sets the motion information of a current block to be the same as the motion information of a neighboring block. In a motion information merge mode, motion information may be decoded/encoded by using a motion information merge list.

A motion information merge candidate may be derived based on the motion information of a neighboring block or a neighboring sample adjacent to a current block. As an example, after pre-defining a reference position around a current block, whether motion information exists at a pre-defined reference position may be checked. When motion information exists at a pre-defined reference position, motion information at a corresponding position may be inserted into a motion information merge list as a motion information merge candidate.

In an example of FIG. 7, a pre-defined reference position may include at least one of A0, A1, B0, B1, B5 and Col. Furthermore, a motion information merge candidate may be derived in the order of A1, B1, B0, A0, B5 and Col.

Among the motion information merge candidates included in a motion information merge list, the motion information of a motion information merge candidate having an optimal cost may be set as the motion information of a current block. Furthermore, index information (e.g., a merge index) indicating a motion information merge candidate selected among a plurality of motion information merge candidates may be encoded and signaled to a decoder.

In a decoder, a motion information merge list may be constructed in the same way as in an encoder. And, a motion information merge candidate may be selected based on a merge index decoded from a bitstream. The motion information of a selected motion information merge candidate may be set as the motion information of a current block.

Unlike a motion vector prediction list, a motion information merge list is constructed as a single list regardless of a prediction direction. In other words, a motion information merge candidate included in a motion information merge list may have only L0 motion information or L1 motion information, or may have bidirectional motion information (i.e., L0 motion information and L1 motion information).

A reconstructed sample region around a current block may be used to derive the motion information of a current block. Here, a reconstructed sample region used to derive the motion information of a current block may also be called a template.

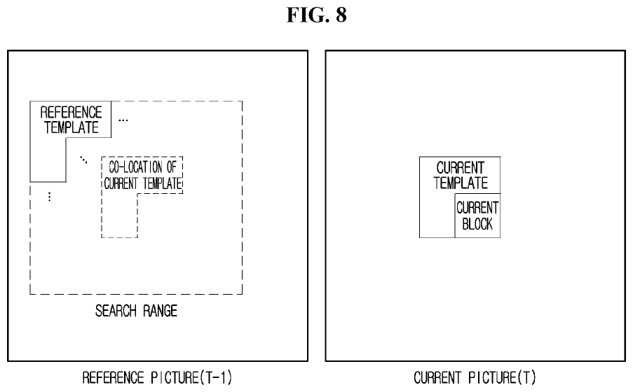

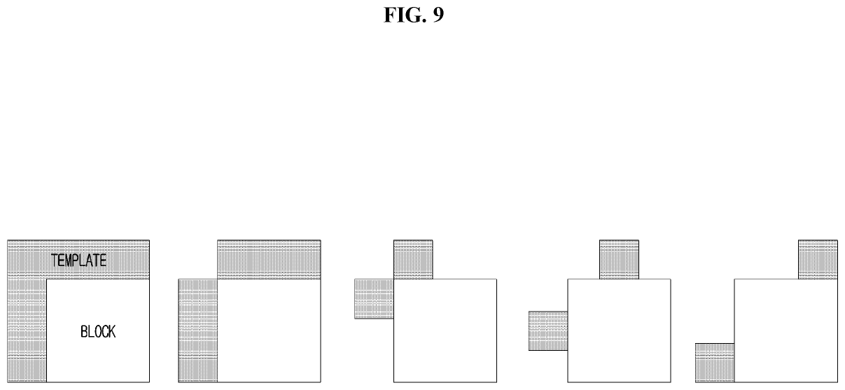

FIG. 8 is a diagram for describing a template-based motion estimation method.

In FIG. 4, it was described that a prediction block of a current block is determined based on a cost between a current block and a reference block within a search range. According to this embodiment, unlike FIG. 4, motion estimation for a current block may be performed based on a cost between a template neighboring a current block (hereinafter, referred to as a current template) and a reference template having the same size and shape as a current template.

As an example, a cost may be calculated based on a SAD between reconstructed samples in a current template and reconstructed samples in a reference block. As a SAD is smaller, a cost may be reduced.

When a current template in a search range and a reference template having an optimal cost are determined, a reference block neighboring a reference template may be set as a prediction block of a current block.

And, the motion information of a current block may be set based on a distance between a current block and a reference block, an index of a picture to which a reference block belongs, and whether a reference picture is included in an L0 or L1 reference picture list.

Since a pre-reconstructed region around a current block is defined as a template, a decoder itself may perform motion estimation in the same manner as an encoder. Accordingly, when motion information is derived by using a template, there is no need to encode and signal motion information other than information representing whether to use a template.

A current template may include at least one of a region adjacent to the top of a current block or a region adjacent to the left of a current block. In this case, a region adjacent to the top may include at least one row, and a region adjacent to the left may include at least one column.

FIG. 9 shows examples in which a template is configured.

A current template may be configured according to one of the examples shown in FIG. 9.

Alternatively, unlike an example shown in FIG. 9, a template may be configured only with regions adjacent to the left of a current block, or a template may be configured only with regions adjacent to the top of a current block.

A size and/or a shape of a current template may be predefined in an encoder and a decoder.

Alternatively, after pre-defining a plurality of template candidates having a different size and/or shape, index information specifying one of a plurality of template candidates may be encoded and signaled to a decoder.

Alternatively, one of a plurality of template candidates may be adaptively selected based on at least one of a size, a shape or a position of a current block. As an example, when a current block adjoins a top boundary of a CTU, a current template may be configured only with regions adjacent to the left of a current block.

Template-based motion estimation may be performed on each reference picture stored in a reference picture list. Alternatively, motion estimation may be performed on only some of the reference pictures. As an example, motion estimation may be performed only for a reference picture whose reference picture index is 0, or motion estimation may be performed only for reference pictures whose reference picture index is less than a threshold value or reference pictures whose POC difference with a current picture is less than a threshold value.

Alternatively, motion estimation may be performed only for a reference picture indicated by the reference picture index after explicitly encoding and signaling a reference picture index.

Alternatively, motion estimation may be performed for a reference picture of a neighboring block corresponding to a current template. As an example, if a template is composed of a left adjacent region and a top adjacent region, at least one reference picture may be selected by using at least one of a reference picture index of a left neighboring block or a reference picture index of a top neighboring block. Afterwards, motion estimation may be performed for at least one selected reference picture.

Information representing whether template-based motion estimation is applied may be encoded and signaled to a decoder. The information may be a 1-bit flag. As an example, when the flag is true (1), it indicates that template-based motion estimation is applied to an L0 direction and an L1 direction of a current block. On the other hand, when the flag is false (0), it indicates that template-based motion estimation is not applied. In this case, motion information of a current block may be derived based on a motion information merge mode or a motion vector prediction mode.

Conversely, only when it is determined that a motion information merge mode and a motion vector prediction mode are not applied to a current block, template-based motion estimation may be applied. As an example, when both a first flag representing whether a motion information merge mode is applied and a second flag representing whether a motion vector prediction mode is applied are 0, template-based motion estimation may be performed.

Information representing whether template-based motion estimation is applied may be signaled for each of an L0 direction and an L1 direction. In other words, whether template-based motion estimation is applied to an L0 direction and whether template-based motion estimation is applied to an L1 direction may be determined independently. Accordingly, template-based motion estimation may be applied to any one of an L0 direction and an L1 direction, while a different mode (e.g., a motion information merge mode or a motion vector prediction mode) may be applied to the other.

When template-based motion estimation is applied to both an L0 direction and an L1 direction, a prediction block of a current block may be generated based on the weighted sum operation of an L0 prediction block and an L1 prediction block. Alternatively, even when template-based motion estimation is applied to one of an L0 direction and an L1 direction, but a different mode is applied to the other, a prediction block of a current block may be generated based on the weighted sum operation of an L0 prediction block and an L1 prediction block.

Alternatively, a template-based motion estimation method may be inserted as a motion information merge candidate on a motion information merge mode or a motion vector prediction candidate on a motion vector prediction mode. In this case, whether to apply a template-based motion estimation method may be determined based on whether a selected motion information merge candidate or a selected motion vector prediction candidate indicates a template-based motion estimation method.

Based on a bilateral matching method, the motion information of a current block may also be generated.

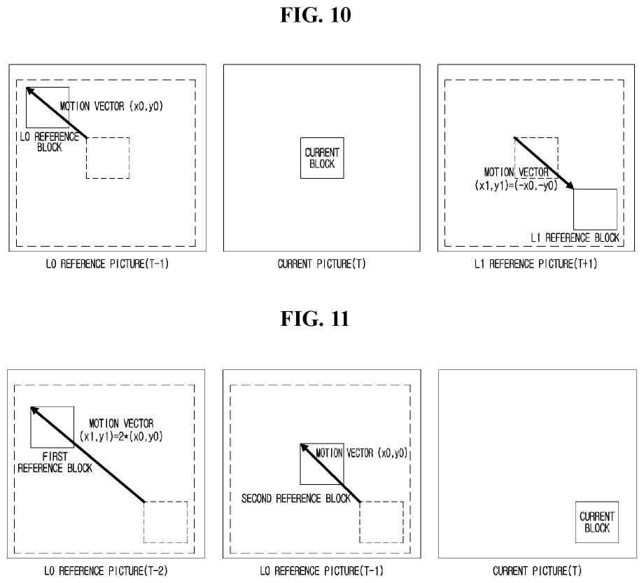

FIG. 10 is a diagram for describing a motion estimation method based on a bilateral matching method.

A bilateral matching method may be performed only when the temporal order (i.e., POC) of a current picture exists between the temporal order of an L0 reference picture and the temporal order of an L1 reference picture.

When a bilateral matching method is applied, a search range may be set for each of an L0 reference picture and an L1 reference picture. In this case, an L0 reference picture index for identifying an L0 reference picture and an L1 reference picture index for identifying an L1 reference picture may be encoded and signaled, respectively.

As another example, only an L0 reference picture index may be encoded and signaled, and an L1 reference picture may be selected based on a distance between a current picture and an L0 reference picture (hereinafter, referred to as an L0 POC difference). As an example, among the L1 reference pictures included in an L1 reference picture list, an L1 reference picture that an absolute value of a distance with a current picture (hereinafter, referred to as an L1 POC difference) is the same as an absolute value of a distance between a current picture and an L0 reference picture may be selected. When there is no L1 reference picture having the same L1 POC difference as an L0 POC difference, an L1 reference picture that an L1 POC difference is most similar to an L0 POC difference may be selected among the L1 reference pictures.

In this case, only an L1 reference picture whose temporal direction is different from that of an L0 reference picture among the L1 reference pictures may be used for bilateral matching. As an example, when a POC of an L0 reference picture is smaller than that of a current picture, one of the L1 reference pictures whose POC is larger than that of a current picture may be selected.

Conversely, only an L1 reference picture index may be encoded and signaled, and an L0 reference picture may be selected based on a distance between a current picture and an L1 reference picture.

Alternatively, a bilateral matching method may be performed by using an L0 reference picture closest to a current picture among the L0 reference pictures and an L1 reference picture closest to a current picture among the L1 reference pictures.

Alternatively, a bilateral matching method may be performed by using an L0 reference picture (e.g., index 0) to which a predefined index in an L0 reference picture list is allocated and an L1 reference picture (e.g., index 0) to which a predefined index in an L1 reference picture list is allocated.

Alternatively, an LX (X is 0 or 1) reference picture may be selected based on an explicitly signaled reference picture index, and an L|X−1| reference picture may be selected as a reference picture closest to a current picture among the L|X−1| reference pictures or a reference picture having a predefined index in an L|X−1| reference picture list.

As another example, L0 and/or L1 reference pictures may be selected based on the motion information of a neighboring block of a current block. As an example, L0 and/or L1 reference pictures to be used for bilateral matching may be selected by using a reference picture index of a left or top neighboring block of a current block.

A search range may be set within a predetermined range from a collocated block in a reference picture.

As another example, a search range may be set based on initial motion information. Initial motion information may be derived from a neighboring block of a current block. As an example, the motion information of a left neighboring block or a top neighboring block of a current block may be set as the initial motion information of a current block.

When a bilateral matching method is applied, an L0 motion vector and a motion vector in an L1 direction are set in an opposite direction. It represents that a sign of an L0 motion vector is opposite to a sign of a motion vector in an L1 direction. In addition, a size of an LX motion vector may be proportional to a distance between a current picture and an LX reference picture (i.e., a POC difference).

Afterwards, motion estimation may be performed by using a cost between a reference block belonging to a search range of an L0 reference picture (hereinafter, referred to as an L0 reference block) and a reference block belonging to a search range of an L1 reference picture (hereinafter, referred to as an L1 reference block).

When an L0 reference block that a vector with a current block is (x, y) is selected, an L1 reference block at a position spaced by (−Dx, −Dy) from a current block may be selected. Here, D may be determined by a ratio of a distance between a current picture and an L0 reference picture and a distance between an L1 reference picture and a current picture.

As an example, in an example shown in FIG. 10, an absolute value of a distance between a current picture (T) and an L0 reference picture (T−1) is mutually the same as an absolute value of a distance between a current picture (T) and an L1 reference picture (T+1). Accordingly, in a shown example, an L0 motion vector (x0, y0) and an L1 motion vector (x1, y1) have the same size, but an opposite direction. If an L1 reference picture that a POC is (T+2) is used, an L1 motion vector (x1, y1) will be set as (−2*x0, −2*y0).

When an L0 reference block and an L1 reference block having an optimal cost are selected, each of an L0 reference block and an L1 reference block may be set as an L0 prediction block and an L1 prediction block of a current block. Afterwards, a final prediction block of a current block may be generated through a weighted sum operation of an L0 reference block and an L1 reference block.

When a bilateral matching method is applied, a decoder may perform motion estimation in the same manner as an encoder. Accordingly, information representing whether a bilateral motion matching method is applied may be explicitly encoded/decoded, while decoding/encoding of motion information such as a motion vector, etc. may be omitted. As described above, at least one of an L0 reference picture index or an L1 reference picture index may be explicitly encoded/decoded.

As another example, when information representing whether a bilateral matching method is applied is explicitly encoded/decoded, but a bilateral matching method is applied, an L0 motion vector or an L1 motion vector may be explicitly encoded and signaled. When an L0 motion vector is signaled, an L1 motion vector may be derived based on a POC difference between a current picture and an L0 reference picture and a POC difference between a current picture and an L1 reference picture. When an L1 motion vector is signaled, an L0 motion vector may be derived based on a POC difference between a current picture and an L0 reference picture and a POC difference between a current picture and an L1 reference picture. In this case, an encoder may explicitly encode the smaller one between an L0 motion vector and an L1 motion vector.

Information representing whether a bilateral matching method is applied may be a 1-bit flag. As an example, when the flag is true (e.g., 1), it may represent that a bilateral matching method is applied to a current block. When the flag is false (e.g., 0), it may represent that a bilateral matching method is not applied to a current block. In this case, a motion information merge mode or a motion vector prediction mode may be applied to a current block.

Conversely, a bilateral matching method may be applied only when it is determined that a motion information merge mode and a motion vector prediction mode are not applied to a current block. As an example, when both a first flag representing whether a motion information merge mode is applied and a second flag representing whether a motion vector prediction mode is applied are 0, a bilateral matching method may be applied.

Alternatively, a bilateral matching method may be inserted as a motion information merge candidate on a motion information merge mode or a motion vector prediction candidate on a motion vector prediction mode. In this case, whether to apply a bilateral matching method may be determined based on whether a selected motion information merge candidate or a selected motion vector prediction candidate indicates a bilateral matching method.

In a bilateral matching method, it was illustrated that the temporal order of a current picture must exist between the temporal order of an L0 reference picture and the temporal order of an L1 reference picture. A unidirectional matching method to which a constraint of the bilateral matching method is not applied may be applied to generate a prediction block of a current block. Specifically, in a unidirectional matching method, two reference pictures having temporal order smaller than that of a current block (i.e., a POC) or two reference pictures having temporal order larger than that of a current block may be used. In this case, two reference pictures may be derived from an L0 reference picture list or an L1 reference picture list. Alternatively, one of the two reference pictures may be derived from an L0 reference picture list and the other may be derived from an L1 reference picture list.

FIG. 11 is a diagram for describing a motion estimation method based on a unilateral matching method.

A unilateral matching method may be performed based on two reference pictures having a POC smaller than that of a current picture (i.e., forward reference pictures) or two reference pictures having a POC larger than that of a current picture (i.e., backward reference pictures). In FIG. 11, it was illustrated that motion estimation based on a unilateral matching method is performed based on a first reference picture (T−1) and a second reference picture (T−2) having a POC smaller than that of a current picture (T).

In this case, a first reference picture index for identifying a first reference picture and a second reference picture index for identifying a second reference picture may be encoded and signaled, respectively. In this case, among two reference pictures used for a unilateral matching method, a reference picture having a smaller POC difference from a current picture may be set as a first reference picture. Accordingly, when a first reference picture is selected, only reference pictures having a larger POC difference from a current picture than a first reference picture among the reference pictures included in a reference picture list may be set as a second reference picture. A second reference picture index may be set to indicate an index of one of the reordered reference pictures after reordering reference pictures having the same temporal direction as a first reference picture and having a larger POC difference from a current picture than a first reference picture.

Conversely, a reference picture having a larger POC difference from a current picture among the two reference pictures may be set as a first reference picture. In this case, a second reference picture index may be set to indicate an index of one of the reordered reference pictures after reordering reference pictures having the same temporal direction as a first reference picture and having a smaller POC difference from a current picture than a first reference picture.

Alternatively, a unilateral matching method may be performed by using a reference picture to which a predefined index in a reference picture list is allocated and a reference picture having the same temporal direction. As an example, a reference picture having an index of 0 in a reference picture list may be set as a first reference picture, and a reference picture having the smallest index among the reference pictures having the same temporal direction as a first reference picture in a reference picture list may be selected as a second reference picture.

Both a first reference picture and a second reference picture may be selected from an L0 reference picture list or an L1 reference picture list. In FIG. 11, it was shown that two L0 reference pictures are used for a unilateral matching method. Alternatively, a first reference picture may be selected from an L0 reference picture list, and a second reference picture may be selected from an L1 reference picture list.

Information representing whether a first reference picture and/or a second reference picture belongs to an L0 reference picture list or an L1 reference picture list may be additionally encoded/decoded.

Alternatively, unilateral matching may be performed by using one of an L0 reference picture list and an L1 reference picture list set as default. Alternatively, two reference pictures may be selected from an L0 reference picture list and an L1 reference picture list, whichever has a larger number of reference pictures.

Afterwards, a search range within a first reference picture and a second reference picture may be set.

A search range may be set within a predetermined range from a collocated block in a reference picture.

As another example, a search range may be set based on initial motion information. Initial motion information may be derived from the neighboring block of a current block. As an example, the motion information of a left neighboring block or a top neighboring block of a current block may be set as the initial motion information of a current block.

Afterwards, motion estimation may be performed by using a cost between a first reference block belonging to the search range of a first reference picture and a second reference block belonging to the search range of a second reference picture.

In this case, under a unilateral matching method, the size of a motion vector must be set to increase in proportion to a distance between a current picture and a reference picture. Specifically, when a first reference block whose vector with a current picture is (x, y) is selected, a second reference block must be separated from a current block by (Dx, Dy). Here, D may be determined by the ratio of a distance between a current picture and a first reference picture and a distance between a current picture and a second reference picture.

As an example, in an example of FIG. 11, a distance between a current picture and a first reference picture (i.e., a POC difference) is 1, and a distance between a current picture and a second reference picture (i.e., a POC difference) is 2. Accordingly, when a first motion vector for a first reference block in a first reference picture is (x0, y0), a second motion vector (x1, y1) for a second reference block in a second reference picture may be set as (2×0, 2y0).

When a first reference block and a second reference block having an optimal cost are selected, a first reference block and a second reference block may be set as a first prediction block and a second prediction block of a current block, respectively. Afterwards, the final prediction block of a current block may be generated through the weighted sum operation of a first prediction block and a second prediction block.

When a unilateral matching method is applied, a decoder may perform motion estimation in the same manner as an encoder. Accordingly, information representing whether a unilateral motion matching method is applied is explicitly encoded/decoded, while encoding/decoding of motion information such as a motion vector, etc. may be omitted. As described above, at least one of a first reference picture index or a second reference picture index may be explicitly encoded/decoded.

As another example, information representing whether a unilateral matching method is applied is explicitly encoded/decoded, and when a unilateral matching method is applied, a first motion vector or a second motion vector may be explicitly encoded and signaled. When a first motion vector is signaled, a second motion vector may be derived based on a POC difference between a current picture and a first reference picture and a POC difference between a current picture and a second reference picture. When a second motion vector is signaled, a first motion vector may be derived based on a POC difference between a current picture and a first reference picture and a POC difference between a current picture and a second reference picture. In this case, an encoder may explicitly encode the smaller one of a first motion vector and a second motion vector.

Information representing whether a unilateral matching method is applied may be a 1-bit flag. As an example, when the flag is true (e.g., 1), it may represent that a unilateral matching method is applied to a current block. When the flag is false (e.g., 0), it may represent that a unilateral matching method is not applied to a current block. In this case, a motion information merging mode or a motion vector prediction mode may be applied to a current block.

Conversely, a unilateral matching method may be applied only when it is determined that a motion information merging mode and a motion vector prediction mode are not applied to a current block. As an example, when both a first flag representing whether a motion information merging mode is applied and a second flag representing whether a motion vector prediction mode is applied are 0, a unilateral matching method may be applied.

Alternatively, a unilateral matching method may be inserted as a motion information merge candidate in a motion information merge mode or a motion vector prediction candidate in a motion vector prediction mode. In this case, whether to apply a unilateral matching method may be determined based on whether a selected motion information merge candidate or a selected motion vector prediction candidate indicates a unilateral matching method.

The inter motion of an object may be detected by adjusting the precision of a motion vector. Specifically, the position of each pixel within a picture is specified as an integer. On the other hand, the inter motion of an object may not be expressed in an integer position.

By considering this, a motion vector may be searched in a factional pixel unit by performing interpolation on a reference picture.

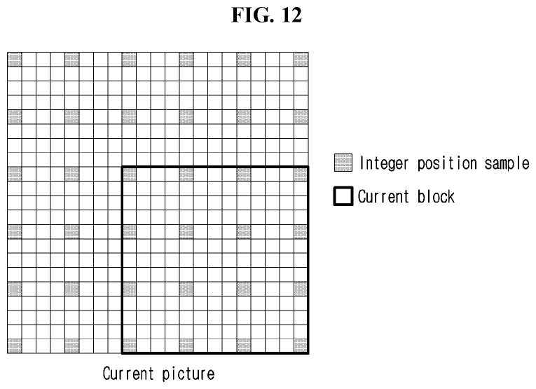

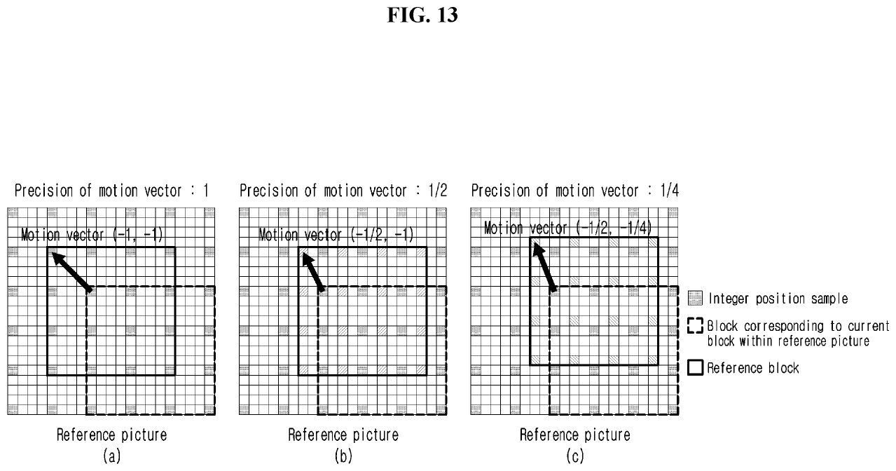

FIGS. 12 and 13 illustrate an example in which a prediction block is generated according to the precision of a motion vector.

FIG. 12 represents the position of a current block within a current picture, and FIG. 13 illustrates an example in which a prediction block is obtained according to a motion vector.

Specifically, FIG. 13(a) represents an example of a case in which motion vector precision is an integer pixel unit, and FIGS. 13(b) and (c) represent an example of a case in which motion vector precision is a 1/2-pixel unit and a 1/4-pixel unit, respectively.

Motion vector precision may also be set in a unit smaller than that illustrated. As an example, motion vector precision may be set in a 1/8-pixel unit, a 1/16-pixel unit or a 1/32-pixel unit.

When the motion vector of a current block is represented in an integer unit, as in an example illustrated in FIG. 13(a), a reference block composed of integer position samples may be set as the prediction block of a current block.

On the other hand, when the motion vector of a current block is represented in a fractional unit, as in an example illustrated in FIGS. 13(b) and (c), a reference block composed of fractional position samples may be set as the prediction block of a current block. In this case, a fractional position sample within a reference block may be generated by interpolating integer position samples. An interpolation filter may have a size of 4 or 8 taps.

As another example, in order to reduce complexity, a fractional position sample may be generated through linear interpolation using only integer position samples adjacent to a fractional position.

Information indicating the motion vector precision of a current block may be encoded and signaled. As an example, after allocating a different index to each of a plurality of motion vector precision candidates, the index of a motion vector precision candidate corresponding to the motion vector precision of a current block may be encoded and signaled.

In this case, the number and/or type of available motion vector candidates may be determined based on at least one of the size of a current block, the shape of a current block, a reference picture or a motion compensation model. Here, a motion compensation model may include at least one of a translation model, a zooming model or a rotation model. A motion compensation model that at least one of a zooming model or a rotation model is combined with a translation model may be referred to as an affine model.

An index indicating one of the motion vector candidates available for a current block may be encoded. The maximum number of bits required to encode an index may be determined according to the number of motion vector candidates available for a current block.

By adjusting the precision of a motion vector, a motion vector may be searched more precisely, thereby improving prediction accuracy for a current block.

Meanwhile, a motion vector expressed as a fractional position may be scaled up to an integer and encoded.

Compensation for the motion of an object may be performed based on at least one of a translation model for compensating for the linear motion of an object (e.g., a motion in a horizontal and/or vertical direction), a zooming model for compensating for the size change of an object and a rotation model for compensating for the rotational motion of an object. Here, zooming may represent size enlargement or size reduction.

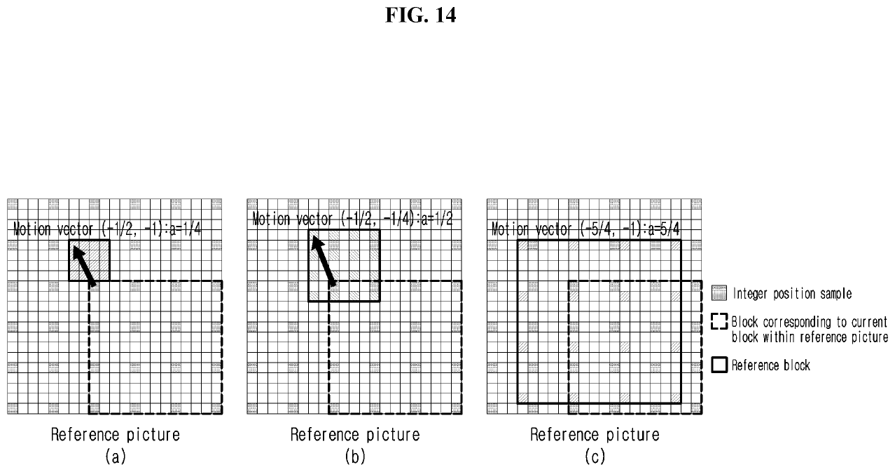

FIG. 14 represents an example in which motion compensation based on a translation model and a zooming model is performed for a current block.

For convenience of a description, as illustrated in FIG. 12, it is assumed that a current block has a size of 4×4.

In FIG. 14, variable a represents a size adjustment parameter. The size of a reference block may be derived by multiplying the size of a current block by variable α.

When size adjustment parameter a is less than 1, it represents that a reference block is smaller than a current block, and when size adjustment parameter a is greater than 1, it represents that a reference block is larger than a current block.

FIGS. 14(a) and (b) represent an example of a case in which size adjustment parameter a is less than 1, and FIG. 14(c) represents an example of a case in which size adjustment parameter a is greater than 1.

The top-left position of a reference block may be specified based on the motion vector of a current block. Specifically, a position spaced apart by a motion vector from a position corresponding to the top-left sample of a current block within a reference picture may be set as the top-left position of a reference block. Afterwards, according to a size adjustment parameter, a reference block whose width and height are α times the width and height of a current block may be set. A fractional position sample within a reference block may be generated by interpolating integer position samples.

A reference block derived by a motion vector and a size adjustment parameter may be set as the prediction block of a current block.

Meanwhile, information about size adjustment parameter a may be encoded and signaled.

Specifically, a different index may be allocated to each of a plurality of size adjustment parameter candidates, and an index specifying a size adjustment parameter candidate applied to a current block may be encoded and signaled.

Alternatively, the size adjustment parameter of a current block may be derived based on the size adjustment parameter of a neighbor block. As an example, the size adjustment parameter of a neighbor block at a predefined position may be set as the size adjustment parameter of a current block.

Alternatively, when sequentially searching for a plurality of neighbor blocks, the size adjustment parameter of the first searched available neighbor block may be set as the size adjustment parameter of a current block.

Alternatively, the size adjustment parameter of a neighbor block may be set as a size adjustment parameter candidate. In this case, a size adjustment parameter candidate list including a plurality of size adjustment parameter candidates may be generated by sequentially searching a plurality of neighbor blocks. One of a plurality of size adjustment parameter candidates included in a plurality of size adjustment parameter candidate lists may be set as the size adjustment parameter of a current block. In this case, an index indicating the same candidate as the size adjustment parameter of a current block among a plurality of size adjustment parameter candidates may be encoded and signaled.

Meanwhile, a neighbor block used to derive the size adjustment parameter of a current block may include at least one of a top neighbor block, a left neighbor block, a top-left neighbor block, a top-right neighbor block or a bottom-left neighbor block.

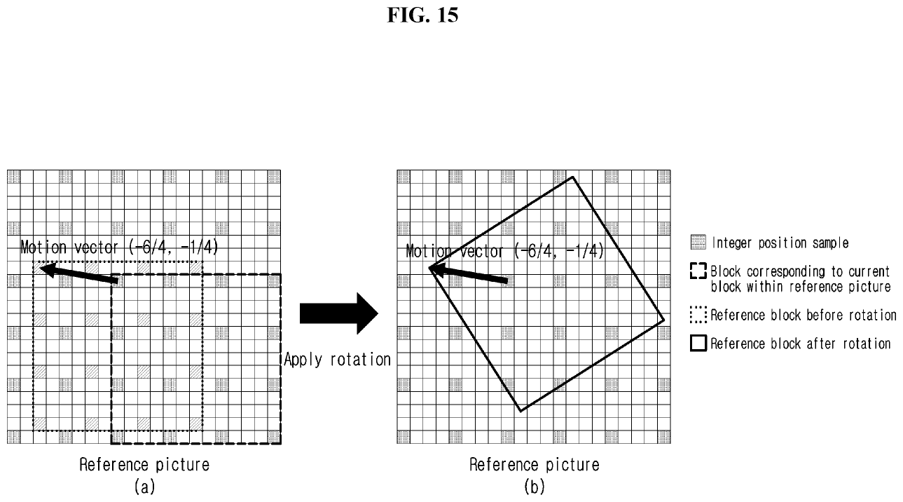

FIG. 15 represents an example in which motion compensation based on a translation model and a rotation model is performed for a current block.

For convenience of a description, as illustrated in FIG. 12, it is assumed that a current block has a size of 4×4.

First, as in an example illustrated in FIG. 15(a), the position of a temporary block within a reference picture may be specified based on the motion vector of a current block. Specifically, a block position may be specified that uses a position spaced apart by a motion vector from a position corresponding to the top-left sample of a current block within a reference picture as a top-left sample.

Afterwards, as in an example illustrated in FIG. 15(b), a temporary block may be rotated. A block at a rotated position may be set as a reference block, and a reference block may be set as the prediction block of a current block.

Meanwhile, a rotation matrix may be used to rotate a temporary block specified by a motion vector. In other words, a prediction sample for a current block may be set as a sample at a position obtained by applying a rotation matrix to a sample position within a temporary block.

Equation 1 represents a rotation matrix.

$$[ {pos\_x}^{′} , {pos\_y}^{′} ] = [ pos\_x , pos\_y ] [ \begin{matrix}cos θ & - sin θ \\ sin θ & cos θ\end{matrix} ] \qquad [ Equation 1 ]$$

In Equation 1 above, (pos_x, pos_y) represents the position of a sample within a temporary block. In other words, (pos_x, pos_y) may be derived by adding a motion vector to the position of a prediction target sample within a current block.

(pos_x′, pos_y′) represents a position rotated from the position of a sample within a temporary block, and θ refers to a rotation angle.

A sample value at a position of (pos_x′, pos_y′) within a reference picture may be set as the value of a prediction sample for the position of a prediction target sample. When a position of (pos_x′, pos_y′) is a fractional position, a sample at a corresponding position may be generated by interpolating integer position samples.

Meanwhile, information representing rotation angle θ may be encoded and signaled. As an example, after allocating a different index to each of a plurality of rotation angle candidates, the index of a rotation angle candidate corresponding to the rotation angle of a current block may be encoded and signaled.

Alternatively, the rotation angle of a current block may be derived based on the rotation angle of a neighbor block. As an example, the rotation angle of a neighbor block at a predefined position may be set as the rotation angle of a current block.

Alternatively, when sequentially searching for a plurality of neighbor blocks, the rotation angle of the first searched available neighbor block may be set as the rotation angle of a current block.

Alternatively, the rotation angle of a neighbor block may be set as a rotation angle candidate. In this case, a rotation angle candidate list including a plurality of rotation angle candidates may be generated by sequentially searching a plurality of neighbor blocks. One of a plurality of rotation angle candidates included in a plurality of rotation angle candidate lists may be set as the rotation angle of a current block. In this case, an index indicating the same candidate as the rotation angle of a current block among a plurality of rotation angle candidates may be encoded and signaled.

Meanwhile, a neighbor block used to derive the rotation angle of a current block may include at least one of a top neighbor block, a left neighbor block, a top-left neighbor block, a top-right neighbor block or a bottom-left neighbor block.

Although not illustrated, motion compensation for a current block may also be performed by simultaneously applying a translation model, a zooming model and a rotation model.

Meanwhile, motion vector precision for a current block or the number and/or type of motion vector precision candidates available for a current block may be determined differently according to a motion compensation model.

As an example, the number and/or type of motion vector precision candidates available for a current block may be different between a case in which only a translation model is applied and a case in which at least one of a zooming model or a rotation model is applied.

As a specific example, when a translation model is applied to a current block, candidates in at least a 1/4-pixel unit may be available for a current block. On the other hand, when at least one of a zooming model or a rotation model along with a translation model is additionally applied to a current block, candidates in at least a 1/16-pixel unit may be available for a current block.

Alternatively, when a translation model is applied to a current block, the motion vector precision of a current block may be set in a 1/4-pixel unit. On the other hand, when at least one of a zooming model or a rotation model along with a translation model is additionally applied to a current block, the motion vector precision of a current block may be set in a 1/16-pixel unit.

Meanwhile, available motion vector precision or available motion vector precision candidates for each motion compensation model may be pre-stored in an encoder and a decoder. Alternatively, information representing available motion vector precision or available motion vector precision candidates for each motion compensation model may be encoded and signaled through a higher header.

The motion vector of a control point may be used to perform motion compensation on an affine model that a zooming model and/or a rotation model is added to a translation model. Here, a control point may correspond to the corner of a current block. As an example, in order to perform motion compensation based on an affine model, at least one of the motion vector of a top-left corner, the motion vector of a top-right corner or the motion vector of a bottom-left corner may be used.

Hereinafter, the motion vector of a control point will be referred to as a control point motion vector.

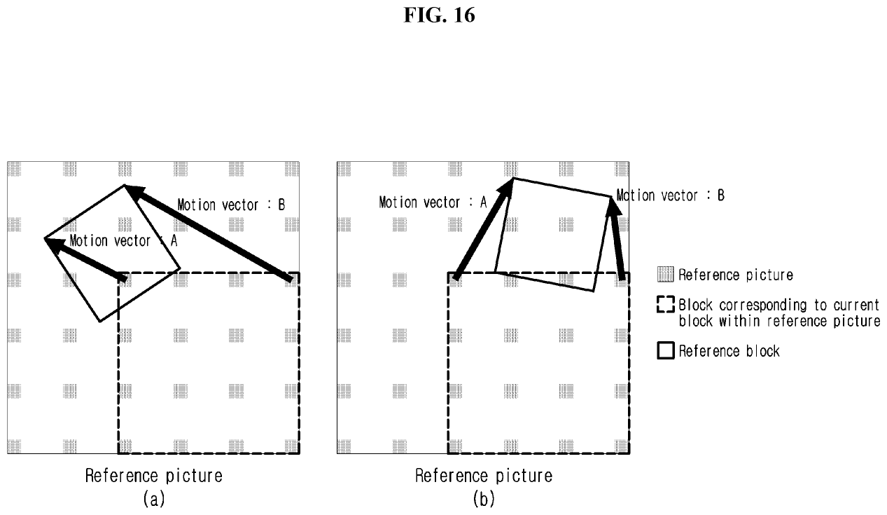

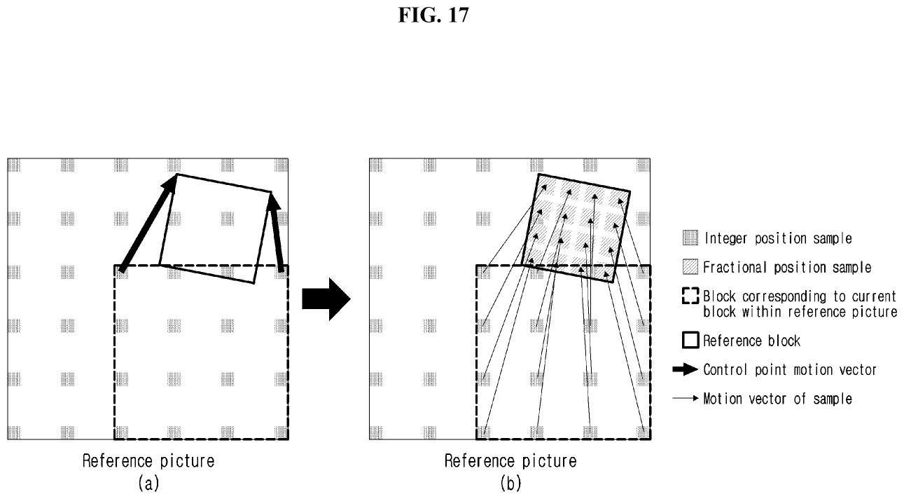

FIGS. 16 and 17 represent an example in which a prediction block for a current block is generated by using control point motion vectors.

For convenience of a description, as illustrated in FIG. 12, it is assumed that a current block has a size of 4×4.

In FIGS. 16(a) and (b), it is illustrated that a prediction block for a current block is derived by the motion vector of the first control point corresponding to the top-left corner of a current block (the first control point motion vector, A) and the motion vector of the second control point corresponding to the top-right corner of a current block (the second control point motion vector, B).

In addition to an illustrated example, the prediction block of a current block may also be derived by additionally using the motion vector of a bottom-left corner or by using the motion vector of a bottom-left corner instead of a top-right corner.

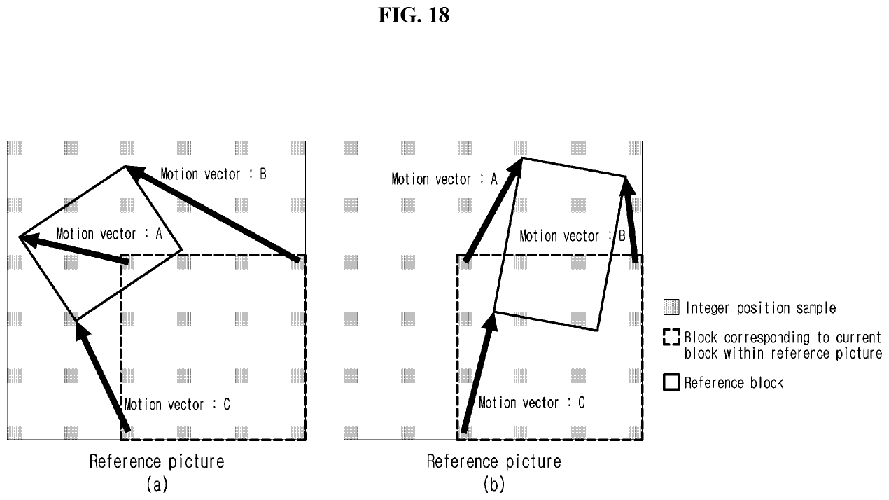

FIG. 18 represents an example in which a prediction block for a current block is generated by using three control point motion vectors.

In FIGS. 18(a) and (b), it is illustrated that a prediction block for a current block is derived by the motion vector of the first control point corresponding to the top-left corner of a current block (the first control point motion vector, A), the motion vector of the second control point corresponding to the top-right corner of a current block (the second control point motion vector, B) and the motion vector of the third control point corresponding to the bottom-left corner of a current block (the third control point motion vector, C).

As in an example illustrated in FIGS. 16 to 18, translation, zooming and rotation motion compensation for a current block may be performed by using two control point motion vectors or three control point motion vectors.

Information representing the number of control point motion vectors may be encoded and signaled. The information may be signaled in a block unit. As an example, the information may indicate whether two or three control point motion vectors are used for a current block.

Alternatively, the number of control point motion vectors may be adaptively determined based on at least one of the size or shape of a current block.

Alternatively, when the control point motion vectors of a current block are derived from a neighbor block, the number of control point motion vectors for a current block may be set to be the same as the number of control point motion vectors of a neighbor block.

The control point motion vectors may be used to derive a motion vector for each sample within a current block. Equation 2 represents a formula for deriving a motion vector for each sample by using two control point motion vectors.

$${mv}_{x} = \frac{m {v}_{B x} - m {v}_{A x}}{W} x + \frac{m {v}_{B y} - m {v}_{A y}}{W} y + m {v}_{A x} \qquad [ Equation 2 ]$$

$$m {v}_{y} = \frac{m {v}_{B y} - m {v}_{A y}}{W} x + \frac{m {v}_{B x} - m {v}_{A x}}{W} y + m {v}_{A y}$$

In Equation 2 above, (mvₓ, mv_{y}) represents a motion vector at a position of (x, y) within a current block. (mv_{Ax}, mv_{Ay}) represents the first control point motion vector (A), and (mv_{Bx}, mv_{By}) represents the second control point motion vector (B). W represents the width of a current block.

When three control point motion vectors are used, a motion vector for each sample may be derived by Equation 3 below.

$$m {v}_{x} = \frac{m {v}_{B x} - m {v}_{A x}}{W} w + \frac{m {v}_{C x} - m {v}_{A x}}{W} y + m {v}_{A x} \qquad [ Equation 3 ]$$

$$m {v}_{y} = \frac{m {v}_{B y} - m {v}_{A y}}{W} x + \frac{m {v}_{C y} - m {v}_{A x}}{W} y + m {v}_{A y}$$

In Equation 3 above, (mv_{Cx}, mv_{Cy}) represents the third control point motion vector (C).

When a motion vector is derived for each sample, as in an example illustrated in FIG. 17, motion compensation on each sample may be performed. Specifically, a reference sample indicated by the motion vector of a prediction target sample may be set as a prediction sample for a prediction target sample.

Meanwhile, when the motion vector of a prediction target sample is expressed in a fractional unit, integer position samples may be interpolated to generate a fractional position sample, and generated fractional position samples may be set as a prediction sample for a prediction target sample.

In this case, the precision of a motion vector for each sample may be different. As an example, while a motion vector for the first prediction target sample is derived in a 1/2-pixel unit, a motion vector for the second prediction target sample may be derived in a 1/4-pixel unit.

In this case, a fractional position sample may be generated according to motion vector precision for each prediction target sample. Alternatively, after adjusting the motion vector of a prediction target sample according to reference motion vector precision, a prediction sample for a prediction target sample may be derived based on an adjusted motion vector. As an example, when reference motion vector precision is 1/2, a motion vector for the second prediction target sample may be adjusted in a 1/4-pixel unit.

The reference motion vector precision may be determined in a block unit. Alternatively, the precision of control point motion vectors may be set as reference motion vector precision. Alternatively, reference motion vector precision may be predefined in an encoder and a decoder.

As another example, a motion vector may be derived in a sub-block unit to reduce complexity.

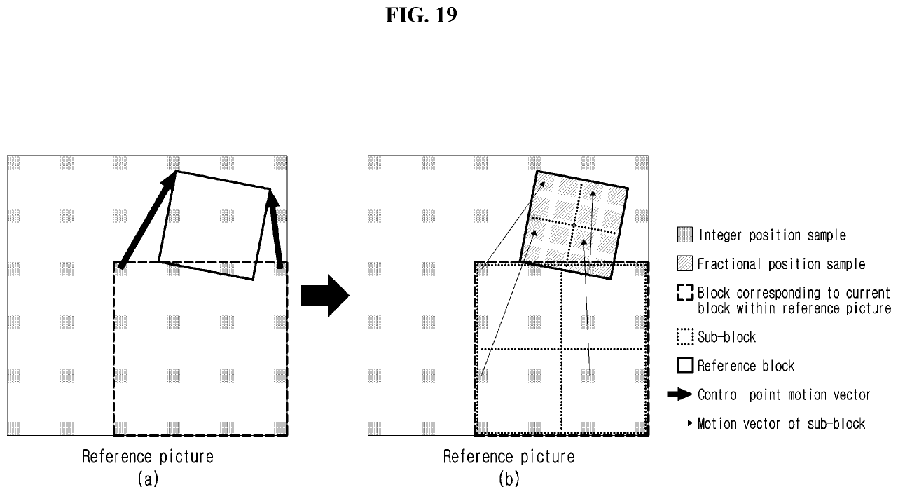

FIG. 19 represents an example in which a motion vector is derived in a sub-block unit.

The size and/or shape of a sub-block may be predefined in an encoder and a decoder. As an example, a sub-block may be a 2×2 or 4×4-sized square block.

Alternatively, the size and/or shape of a sub-block may be adaptively determined according to the size and/or shape of a current block. As an example, when a current block is square, a sub-block may also be square. On the other hand, when a current block is non-square, a sub-block may also be non-square.

Alternatively, information about at least one of the partitioning method or partitioning shape of a current block may be explicitly encoded and signaled. As an example, information about at least one of the size of a sub-block, the shape of a sub-block, the position of a partitioning line partitioning a current block or the number of partitioning lines may be explicitly encoded and signaled. The information may be encoded and signaled in a block unit or may be encoded and signaled through a higher header.

In FIG. 19, it is assumed that a sub-block is a 2×2-sized square block.

The motion vector of a sub-block may be derived by using the coordinates of a predefined position within a sub-block. Here, a predefined position may be one of the position of a top-left sample, the position of a top-right sample, the position of a bottom-left sample, the position of a bottom-right sample or the center position within a sub-block.

By substituting the coordinates of a predefined position within a sub-block into (x, y) in Equation 2, the motion vector of a sub-block may be derived.

As in an example described above, a motion vector may be derived in a sub-block unit based on an affine motion model.

Meanwhile, a collocated picture may be used to derive a motion vector in a sub-block unit. As above, deriving a motion vector in a sub-block unit by using a collocated picture may be called SbTMVP (Sub-block Temporal Motion Vector Prediction).

A collocated picture may be one of the reference pictures included in a reference picture list. As an example, a picture with an index of 0 within a reference picture list may be selected as a collocated picture.

Alternatively, information indicating the index of a reference picture set as a collocated picture within a reference picture list may be explicitly encoded and signaled.

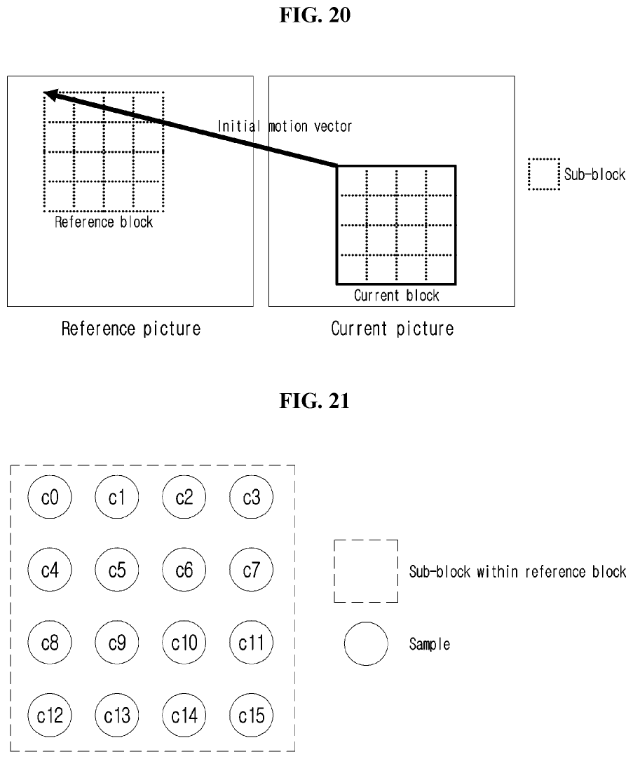

FIGS. 20 and 21 represent an example in which a motion vector is derived in a sub-block unit within a current block when SbTMVP is applied.

The size and/or shape of a sub-block may be predefined in an encoder and a decoder.

Alternatively, the size and/or shape of a sub-block may be adaptively determined according to the size and/or shape of a current block. As an example, when at least one of the width or height of a current block is greater than a threshold value, the size of a sub-block may be set as 8×8. Otherwise, the size of a sub-block may be set as 4×4.

Alternatively, information indicating the size and/or shape of a sub-block may be explicitly encoded and signaled.

In an example illustrated in FIG. 20, it is assumed that the size of a current block is 16×16 and the size of a sub-block is 4×4.

When SbTMVP is applied, the initial motion vector of a current block may be derived. An initial motion vector may be derived based on at least one of a motion vector prediction list or a motion information merge list. As an example, an index indicating one of the motion vector prediction candidates included in a motion vector prediction list may be encoded and signaled. An initial motion vector may be derived by adding a motion vector difference value to a motion vector prediction candidate indicated by the index. Meanwhile, a motion vector difference value may also be explicitly encoded and signaled.

Alternatively, the encoding of an index may be omitted, and a motion vector prediction candidate with a predefined index within a motion vector prediction list may be set as a prediction value for an initial motion vector. Here, a motion vector prediction candidate with a predefined index may be a motion vector prediction candidate with an index of 0 or a motion vector prediction candidate with the largest index.

Alternatively, an index indicating one of the motion information merge candidates included in a motion information merge list may be encoded and signaled. An initial motion vector may be set to be the same as the motion vector of a motion information merge candidate indicated by the index.

Alternatively, the encoding of an index may be omitted, and an initial motion vector may be derived based on a motion information merge candidate with a predefined index within a motion information merge list. Here, a motion information merge candidate with a predefined index may be a motion information merge candidate with an index of 0 or a motion information merge candidate with the largest index.

Alternatively, an initial motion vector may be derived by using the motion vector of a neighbor block at a predefined position. Here, a neighbor block at a predefined position may be a left neighbor block or a top neighbor block.

The motion vector of a neighbor block at a predefined position may be set as the prediction value of an initial motion vector, and a difference value may be added to the prediction value to derive an initial motion vector.

Alternatively, the motion vector of a neighbor block at a predefined position may be set as an initial motion vector.

Alternatively, an initial motion vector may be derived by using a template-based motion estimation method (i.e., a template matching method) or bilateral matching.

The precision of an initial motion vector may be predefined in an encoder and a decoder. As an example, the precision of an initial motion vector may be fixed in an integer pixel unit.

Alternatively, information indicating the precision of an initial motion vector may be explicitly encoded and signaled. The information may be an index indicating one of a plurality of motion vector precision candidates.

When an initial motion vector is derived by using a motion vector prediction candidate, motion vector prediction candidates may be derived based on the motion vector precision of an initial motion vector. In other words, after adjusting a motion vector prediction candidate according to the motion vector precision of an initial motion vector, an adjusted initial motion vector prediction candidate may be inserted into a motion vector prediction list.

When an initial motion vector is derived by using a motion information merge candidate, motion information merge candidates may be derived based on the motion vector precision of an initial motion vector. In other words, after adjusting a motion information merge candidate according to the motion vector precision of an initial motion vector, an adjusted initial motion information merge candidate may be inserted into a motion information merge list.

Meanwhile, only candidates whose reference picture is the same as the collocated picture of a current block among the motion information merge candidates included in a motion information merge list may be used to derive an initial motion vector. In other words, when the reference picture of a motion information merge candidate is different from the collocated picture of a current block, an initial motion vector may not be derived from a corresponding motion information merge candidate.

When there are a plurality of candidates whose reference picture is the same as the collocated picture of a current block among the motion information merge candidates, an index indicating one of a plurality of candidates may be encoded and signaled. Alternatively, when there are a plurality of candidates whose reference picture is the same as the collocated picture of a current block among the motion information merge candidates, an initial motion vector may be derived from a candidate with the smallest index or a candidate with the largest index among a plurality of candidates.

When a motion information merge candidate has both motion information in an L0 direction and motion information in an L1 direction, one of motion information in an L0 direction and motion information in an L1 direction may be selected according to a preset priority, and an initial motion vector may be derived from selected motion information.

A priority may be determined based on at least one of the size of the motion vector of a motion merge candidate, the index of the reference picture of a motion merge candidate or whether the reference picture of a motion merge candidate is the same as a collocated picture.

Alternatively, it may be set to derive an initial motion vector based on motion information in an L0 direction all the time.

When an initial motion vector is derived based on a template matching method, motion estimation may be performed according to the precision of an initial motion vector. As an example, when the precision of an initial motion vector is an integer pixel unit, motion estimation based on template matching may also be performed only at an integer position.

Similarly, when an initial motion vector is derived based on bilateral matching, motion estimation may be performed according to the precision of an initial motion vector.

Meanwhile, as a result of bilateral matching, a motion vector in an L0 direction (an L0 motion vector) and a motion vector in an L1 direction (an L1 motion vector) are derived. In this case, one of an L0 motion vector and an L1 motion vector may be set as an initial motion vector according to a preset priority.

Alternatively, it may be set to derive an initial motion vector based on motion information in an L0 direction all the time.

Alternatively, information indicating which of an L0 motion vector and an L1 motion vector is set as an initial motion vector may be encoded and signaled.

When an initial motion vector is derived, an initial motion vector may be used to determine the position of a collocated block within a collocated block. As an example, a block at a position spaced apart by an initial motion vector from a position corresponding to a current block within a reference picture may be set as a collocated block. In this case, the position of a collocated block may be determined based on a predefined position within a current block. Here, a predefined position may be a top-left position, a top-right position, a bottom-left position, a bottom-right position or the center position.

According to the partitioning method of a current block, a collocated block may be partitioned into a plurality of collocated sub-blocks. And, the motion vector of each collocated sub-block within a collocated block may be set as the motion vector of each sub-block within a current block.

As another example, an initial motion vector may be used to determine the position of collocated sub-blocks corresponding to each sub-block within a current block within a collocated picture. In this case, the position of a collocated sub-block may be derived based on a predefined position within a sub-block. Here, a predefined position may be a top-left position, a top-right position, a bottom-left position, a bottom-right position or the center position.

Afterwards, the motion vector of a collocated sub-block corresponding to a sub-block may be set as the motion vector of a sub-block. Specifically, within a collocated sub-block, a motion vector stored at a position corresponding to a predefined position within a sub-block may be set as the motion vector of a sub-block.

Meanwhile, when the motion information of a collocated sub-block is unavailable, a predefined motion vector may be set as the motion vector of a sub-block. Here, a predefined motion vector may be a zero vector (i.e., (0, 0)) or an initial motion vector.

Alternatively, when the motion information of a collocated sub-block corresponding to a sub-block is unavailable, the motion vector of a sub-block may be derived from another position within a collocated sub-block.

Specifically, within a collocated sub-block, when a position corresponding to a predefined position within a sub-block is encoded by intra prediction, a motion vector does not exist at a corresponding position. As an example, if it is assumed that a predefined position is the center position (e.g., c10 in FIG. 21), when a motion vector is not stored at the center position, the motion vector of a sub-block may not be derived.

In this case, the motion vector of a sub-block may be derived based on a motion vector stored at a position different from the center position. Specifically, a motion vector stored at a position adjacent to the center position (e.g., top adjacent position c6, left adjacent position c9 or top-left adjacent position c5) may be derived as the motion vector of a sub-block.

Alternatively, when the center position is unavailable, samples within a collocated sub-block may be searched according to the scan order, and then, the first discovered available motion vector may be set as the motion vector of a sub-block. Here, scan order may be a horizontal scan, a vertical scan, a diagonal scan or a raster scan.

Alternatively, when the motion information of a collocated sub-block is unavailable, the motion vector of a sub-block may be set as the motion vector of a collocated block. As an example, within a collocated block, a motion vector stored at a position corresponding to a predefined position within a current block may be set as the motion vector of a sub-block.

As in an example described above, a motion vector may be derived in a sub-block unit by using an affine motion model or SbTMVP. When a motion vector is derived in a sub-block unit, motion compensation may be performed on each sub-block based on the motion vector of each sub-block.

By performing motion compensation on each sub-block, a prediction block for a current block may be obtained. In other words, the prediction block may be composed of prediction samples of each sub-block.

When searching for a motion between pictures, motion vector precision may be adjusted. Specifically, the position of each sample within a picture is defined as an integer position. However, a position on which a motion is reflected may be a fractional position, not an integer position.

By considering this, a motion vector may be searched more precisely through reference picture interpolation.

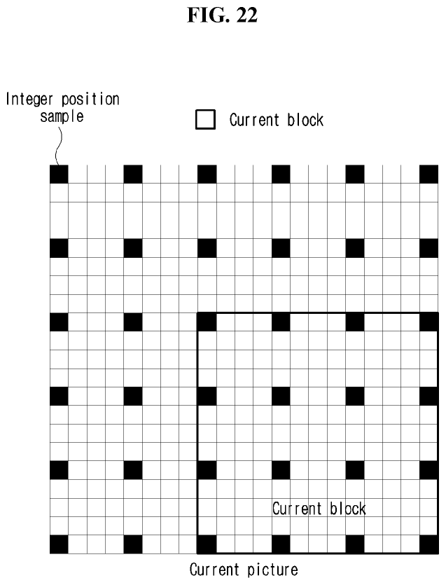

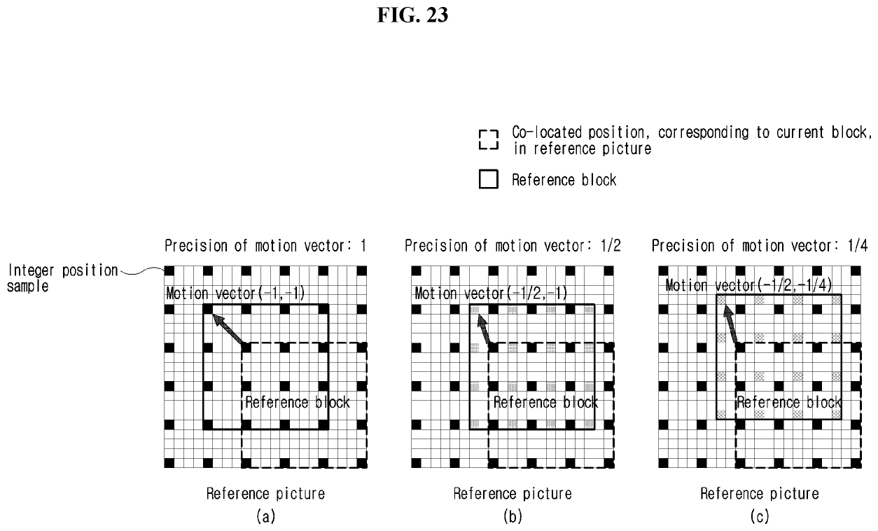

FIGS. 22 and 23 are diagrams representing an example in which a prediction block is derived according to motion vector precision.

FIG. 22 represents the position of a current block within a current picture, and FIG. 23 represents the position of a reference block according to the motion vector precision.

As in an example shown in FIGS. 22 and 23, the motion vector of a current block may be defined as a distance from a sample corresponding to the top-left position of a current block within a reference picture to a sample corresponding to the top-left position of a reference block within a reference picture.

FIG. 23 (a) illustrates a case where the motion vector precision of a current block is an integer pel, and FIG. 23 (b) represents a case where the motion vector precision of a current block is a 1/2-pel. In addition, FIG. 23 (c) illustrates a case where the motion vector precision of a current block is a 1/4-pel.

In FIG. 23, up to 1/4 vector precision is expressed, but a motion vector may also be expressed more precisely such as 1/8, 1/16 or 1/32.

Meanwhile, information for representing the motion vector precision of a current block may be encoded and signaled. As an example, the information may be an index identifying one of the motion vector precision candidates. Specifically, a different index may be allocated to each of the motion vector precision candidates, and the information may indicate the index of a motion vector precision candidate applied to a current block.

By adjusting motion vector precision used for inter prediction, a more precise motion vector search may be possible. When a reference block indicated by a motion vector is positioned at a real number position, samples existing at a real number position may be generated by using samples existing at an integer position and an interpolation filter. In addition, a motion vector expressed as a real number may be scaled up to an integer to be encoded/decoded.

In this way, a motion vector (MV), a motion vector predictor (MVP) and a motion vector difference (MVD) may be encoded/decoded as an integer value through integerization. Specifically, based on motion vector precision, a motion vector, a motion vector prediction value and/or a motion vector difference value may be integerized.

As an example, when motion vector precision is 1/N, integerization may be performed by multiplying a motion vector difference MVD by N. As an example, when a motion vector difference MVD is (4/16, 8/16), a motion vector difference MVD may be integerized by multiplying by 16. In other words, an integerized motion vector difference MVD may be expressed as (4, 8).

Based on motion vector precision, an actual MVD may be derived from an integerized MVD. As an example, when motion vector precision is 1/N, an actual MVD may be derived by dividing an integerized MVD by N. As an example, when an integerized MVD is (4, 8) and motion vector precision is 1/8, an actual MVD may be (4/8, 8/8). Alternatively, when an integerized MVD is (4, 8) and motion vector precision is 1/4, an actual MVD may be (4/4, 8/4).

According to motion vector precision, the expression range of an integerized MVD may be different. As an example, it is assumed that a motion vector difference MVD is (4/16, 8/16) (i.e., (1/4, 2/4)). When motion vector precision is 1/16, an integerized MVD is derived as (4, 8). On the other hand, when motion vector precision is 1/4, an integerized MVD is derived as (1, 2).

Comparing two cases above, when motion vector precision is adjusted from 1/16 to 1/4, the value of an integerized MVD may be reduced from (4, 8) to (1, 2).

Consequently, according to motion vector precision, the number of bits required to encode/decode an integerized motion vector difference MVD may be different. Accordingly, in encoding/decoding a motion vector difference MVD, motion vector precision that may minimize the number of bins may be selected. And, based on the selected motion vector precision, a motion vector difference MVD may be integerized, and an integerized motion vector difference MVD may be encoded/decoded. In addition, information on motion vector precision may be additionally encoded/decoded.

A decoder may reconstruct an actual MVD from a decoded MVD based on motion vector precision. Then, a motion vector MV may be derived by combining a reconstructed MVD and a motion vector predictor MVP.

As above, adjusting the value of a motion vector difference MVD which is encoded/decoded based on motion vector precision is called an Adaptive Motion Vector Resolution (AMVR) method.

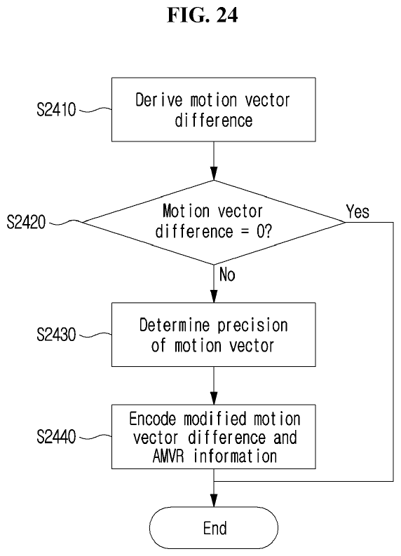

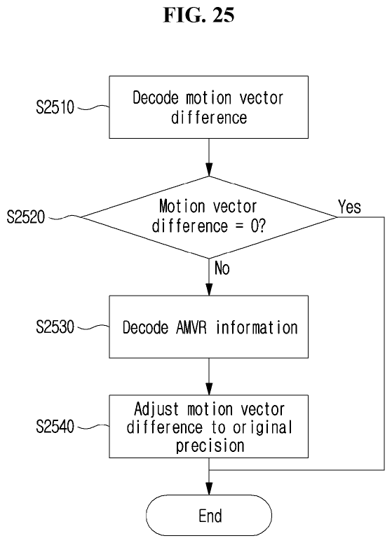

FIGS. 24 and 25 are diagrams for describing the process of encoding and decoding a motion vector difference value when an AMVR method is applied, respectively.

For convenience of a description, it is assumed that a motion vector and a motion vector difference are expressed in the unit of 1/16 before integerization, and 1/16 is referred to as the original motion vector precision.

A motion vector difference MVD may be derived by subtracting a motion vector predictor MVP from a motion vector MV S2410.

A motion vector difference MVD may consist of a horizontal component (i.e., an x-axis component) and a vertical component (i.e., a y-axis component).

When a motion vector difference is 0, i.e., when both a horizontal component and a vertical component are 0, regardless of the motion vector precision, the value of a motion vector difference MVD to be encoded is 0. Accordingly, when a motion vector difference MVD is 0, encoding of AMVR-related information may be omitted S2420.

On the other hand, when a motion vector difference is not 0, i.e., when at least one of a horizontal component and a vertical component is not 0, motion vector precision may be determined S2430. Meanwhile, motion vector precision may be encoded as AMVR-related information.

AMVR-related information may include at least one of a flag (e.g., amvr_flag) representing whether an AMVR method is applied to a current block and an index (e.g., amvr_prec_idx) indicating one of a plurality of motion precision candidates when an AMVR method is applied.

When an AMVR method is not applied to a current block, motion vector precision may be set as a default value. In this case, amvr_flag may be encoded as a value of 0. Meanwhile, a default value may be 1, 1/2, 1/4, 1/8 or 1/16.

When an AMVR method is applied to a current block, an index indicating one of a plurality of motion vector precision candidates, i.e., amvr_prec_idx, may be additionally decoded. In this case, amvr_flag may be encoded as a value of 1, and amvr_prec_idx may be encoded as a value from 0 to (n−1). Here, n represents the number of motion vector precision candidates. As an example, a plurality of motion vector precision candidates may include at least one of 4, 2, 1, 1/2, 1/4, 1/8 or 1/16. Meanwhile, a default value may not be set as one of a plurality of motion vector precision candidates indicated by an index. In other words, when the motion vector precision of a current block is a default value, avmr_flag may be encoded and signaled as a value of 0, and encoding of amvr_prec_idx may be omitted.

An encoder may determine optimal motion vector precision by performing Rate Distortion Optimization (RDO) for each combination of amvr_flag and amvr_prec_idx. In other words, RDO may be performed for the following cases to select a combination with an optimal cost.
1) When amvr_flag is 0
2) When amvr_flag is 1 and amvr_prec_idx is 0
3) When amvr_flag is 1 and amvr_prec_idx is 1
4) When amvr_flag is 1 and amvr_prec_idx is 2

According to the motion vector precision of a current block, a variable for scaling a motion vector difference, i.e., a scaling parameter, may be set. As an example, Table 1 illustrates the value of a variable amvrshift according to motion vector precision.

TABLE 1

| amvr_flag | amvr_prec_idx | amvrshift |
|---|---|---|
| 0 (¼) | — | 2 |
| 1 | 0 (½) | 3 |
| 1 | 1 (1-pel) | 4 |
| 1 | 2 (4-pel) | 6 |

When the optimal motion vector precision that may be applied to a current block is 1/16, motion vector precision may be expressed as in Equation 4 below.

precision of MVD=1/2^{(4-amvrshift)})

As in Table 1, when the value of amvr_flag is 0, a variable amvrshift is set as 2. It represents that motion vector precision is 1/4 according to Equation 4.

When the value of amvr_flag is 1, a variable amvrshft may be determined according to the value of amvr_prec_idx. As an example, when amvr_prec_idx is 1, a variable amvrshift is set as 4. It represents that motion vector precision is 1 according to Equation 4.

An encoder may scale down and encode a motion vector difference MVD by using a variable amvrshift according to motion vector precision. As an example, Equation 5 represents an example in which a scale-down operation is performed on a motion vector difference MVD.

MVD′_x=MVD_x>>amvrshift

MVD′_y=MVD_y>>amvrshift [Equation 5]

In Equation 5 above, MVD_x represents the horizontal component of a motion vector difference, and MVD_y represents the vertical component of a motion vector difference. MVD′_x and MVD′_y represent a result of performing a scale-down operation.

An encoder may encode AMVR information and a motion vector difference with changed precision S2440.

A decoder may decode a motion vector difference MVD S2510.

When a motion vector difference is 0, the decoding of AMVR-related information may be omitted, and the motion vector MV of a current block may be set to be the same as a motion vector predictor S2520.

On the other hand, when a motion vector difference is not 0, i.e., when at least one of a horizontal component and a vertical component is not 0, AMVR-related information may be additionally decoded S2530.

Based on AMVR information, a variable amvrshift for scaling a motion vector difference may be derived. As an example, as in the example of Table 1, a variable amvrshfit may be derived based on amvr_flag and/or amvr_prec_idx.

Afterwards, a variable amvrshift may be used to scale up a decoded MVD, thereby obtaining a motion vector difference MVD reconstructed to its original precision S2540. Equation 6 represents an example in which a scale-up operation is applied to a decoded MVD.

MVD_x=MVD′_x<<amvrshift

MVD_y=MVD′y<<amvrshift [Equation 3]

In Equation 6, MVD′ represents a decoded motion vector difference. A MVD represents a motion vector difference reconstructed to its original precision, i.e., 1/16, through a scale-up operation.

Afterwards, a motion vector MV may be obtained by combining a motion vector difference MVD reconstructed to its original precision and a motion vector predictor MVP.

As in an example described above, when a motion vector prediction mode is applied, a decoder may derive a motion vector MV by combining a motion vector predictor MVP and a motion vector difference MVD.

A color picture may be composed of a plurality of channels. As an example, a color picture may be composed of a Y picture, a Cb picture and a Cr picture. Y represents a luma (or luminance) component, and Cb and Cr represent a chroma (or chrominance) component.

A chroma format may represent the size of a chroma picture compared to a luma picture. As an example, a 4:4:4 format represents that the size of a luma picture is the same as the size of a chroma picture. A 4:2:0 format represents that the width and height of a chroma picture are 1/2 of the width and height of a luma picture, respectively.

In an embodiment described below, a block within a luma picture is referred to as a luma block, and a block within a chroma picture is referred to as a chroma block. A chroma block may represent at least one of a Cb component block or a Cr component block.

For a luma block within a luma picture, the above-described motion information encoding/decoding method may be applied.

On the other hand, the motion information of a chroma block may be derived based on the motion information of a luma block. As an example, when the sizes of a chroma picture and a luma picture are different, the motion information of a chroma block may be derived by scaling the motion vector of a luma block existing at the co-located position of a chroma block according to a chroma format. When a chroma format is 4:2:0, the width and height of a chroma picture are 1/2 of the width and height of a luma picture, respectively. Accordingly, when the x-axis component and y-axis component of the motion vector of a luma block are reduced by 1/2, respectively, (i.e., shifted by 1 to the right), it may be set as the motion vector of a chroma block.

Meanwhile, when the sizes of a chroma picture and a luma picture are the same, i.e., when a chroma format is 4:4:4, the motion information of a luma block may be used as the motion information of a chroma block as it is without performing scaling.

Afterwards, the motion information of a chroma block may be used to specify a reference block within a reference picture, the specified reference block may be set as the prediction block of a chroma block.

Since the motion information of a luma block is inherited to a chroma block, the prediction direction of a chroma block may also be set to be the same as that of a luma block. As an example, when bi-prediction is used for a luma block, bi-prediction may also be applied to a chroma block, and when uni-prediction is used for a luma block, uni-prediction may also be applied to a chroma block.

A chroma block may also be predicted in a method different from that described above. Specifically, after deriving a prediction parameter, a chroma block may be predicted from a luma block corresponding to a chroma block. When a chroma block is predicted from a reconstructed luma block, it may be referred to as a prediction method cross color components based on a prediction parameter. Hereinafter, a prediction method cross color components based on a prediction parameter will be described in detail. Meanwhile, a prediction parameter may be derived by using the same method in each of an encoder and a decoder.

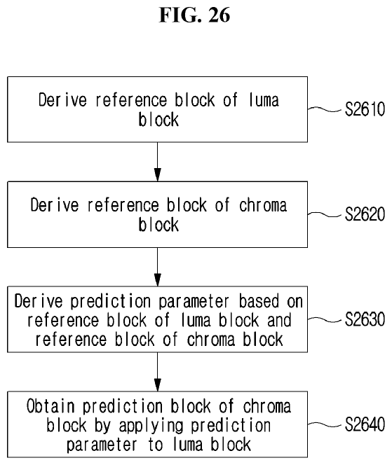

FIG. 26 represents the flowchart of a prediction method cross color components based on a prediction parameter.

The motion information of a luma block at the co-located position of a chroma block where prediction will be performed may be used to derive the reference block of a luma block within a reference picture (hereinafter, referred to as a luma reference block) S2610. As an example, a block at a position spaced apart by the motion vector of a luma block from the position of a luma block within a reference picture may be set as a luma reference block. Here, a reference picture represents a pr-reconstructed luma picture. A luma reference block may be set as the prediction block of a luma block.

Accordingly, in embodiments described below, the prediction block of a luma block (hereinafter, referred to as a luma prediction block) and the reference block of a luma block may be interchangeable. As an example, in embodiments described below, a luma prediction block may be substituted with the reference block of a luma block or the reference block of a luma block may be substituted with a luma prediction block.

The reference block of a chroma block within a reference picture (hereinafter, referred to as a chroma reference block) may be derived S2620. As an example, a block at the co-located position as a luma reference block within a reference picture may be derived as a chroma reference block. Alternatively, after deriving the motion information of a chroma block from a luma block, a chroma reference block may be set based on derived motion information. As an example, a block at a position spaced apart by the motion vector of a chroma block from the position of a chroma block within a reference picture may be set as a chroma reference block. Here, a reference picture represents a pr-reconstructed chroma picture.

Afterwards, a prediction parameter may be derived according to a correlation between a luma prediction block and a chroma reference block S2630. Here, a prediction parameter may include at least one of a weight and an offset.

When a prediction parameter is derived, the prediction sample of a chroma block may be obtained from a reconstructed luma block (hereinafter, a luma reconstructed block) based on a derived prediction parameter S2640.

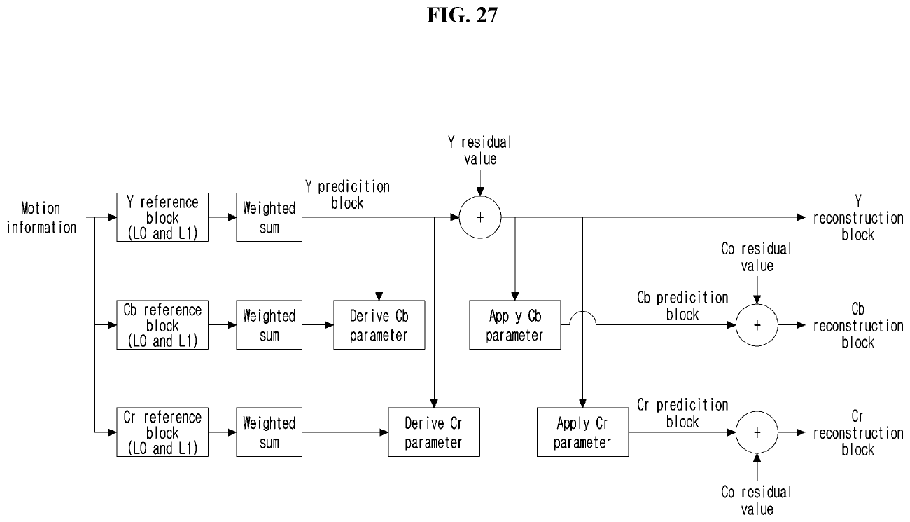

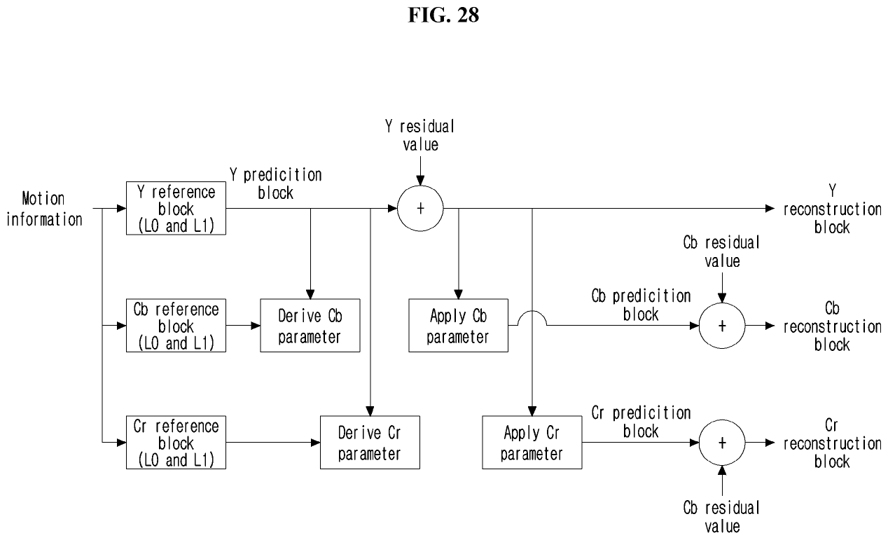

FIGS. 27 and 28 represent the operation of an decoder/a decoder according to a prediction method between color components based on a prediction parameter.

FIG. 27 represents an example of a case in which bi-prediction is applied to a luma block, and FIG. 28 represents an example of a case in which uni-prediction is applied to a luma block.

When bi-prediction is applied to a luma block, a reference block in an L0 direction may be obtained based on the L0 motion information of a luma block and a reference block in an L1 direction may be obtained based on the L1 motion information of a luma block. Each of an L0 reference block and an L1 reference block may be set as an L0 prediction block and an L1 prediction block. Afterwards, the prediction block of a luma block, i.e., a luma prediction block may be obtained based on the average or weighted sum operation of a prediction block in an L0 direction and a prediction block in an L1 direction.

Meanwhile, for a chroma block, a reference block may be derived for each of an L0 direction and an L1 direction. As an example, a Cb component block at the same position as the L0 reference block of a luma block may be set as an L0 reference block for a Cb block, and a Cb component block at the same position as the L1 reference block of a luma block may be set as an L1 reference block for a Cb component block.

Alternatively, the motion information of a Cb block may be derived based on the motion information of a luma block. As an example, the motion vector of a luma block may be set as the motion vector of a Cb block according to a chroma format, or the motion vector of a Cb block may be derived by scaling the motion vector of a luma block. Afterwards, a reference block in an L0 direction may be obtained based on the L0 motion information of a Cb block and a reference block in an L1 direction may be obtained based on the L1 motion information of a Cb block. Afterwards, a weighted summed reference block for a Cb component (hereinafter, referred to as a weighted summed Cb reference block) may be obtained based on the average or weighted sum operation of a reference block in an L0 direction and a prediction block in an L1 direction.

Meanwhile, for a Cr block, a weighted summed reference block for a Cr component (hereinafter, referred to as a weighted summed Cr reference block) may be obtained by using the same method as for a Cb block.

Afterwards, the first prediction parameter for a Cb component may be derived by using a luma prediction block and a weighted summed Cb reference block. In addition, the second prediction parameter for a Cr component may be derived by using a luma prediction block and a weighted summed Cr reference block.

Afterwards, the prediction block of a Cb block may be obtained by applying the first prediction parameter to a luma reconstructed block. Here, a luma reconstructed block may be obtained by adding the residual block of a luma component to a luma prediction block. In addition, the prediction block of a Cr block may be obtained by applying the second prediction parameter to a luma reconstructed block.

A Cb block may be reconstructed by adding the residual block of a Cb component to the prediction block of a Cb block, and a Cr block may be reconstructed by adding the residual block of a Cr component to the prediction block of a Cr block.

When uni-prediction is applied, a weighted sum process may be omitted.

As an example, when L0 prediction is applied to a luma block, a reference block in an L0 direction may be obtained based on the L0 motion information of a luma block and an L0 reference block may be set as the prediction block of a luma block.

For a chroma block, after deriving an L0 reference block, a prediction parameter may be derived based on a correlation between a luma prediction block (i.e., the L0 reference block of a luma component) and the L0 reference block of a chroma block. As an example, the first prediction parameter may be derived based on a luma prediction block and the L0 reference block of a Cb block, and the first prediction parameter may be derived based on a luma prediction block and the L0 reference block of a Cr block.

When L1 prediction is applied to a luma block, a prediction parameter may be derived based on a correlation between a luma prediction block (i.e., the L1 reference block of a luma component) and the L1 reference block of a chroma block.

For simplicity, when bi-prediction is applied to a luma block, a prediction parameter may be derived by using reference blocks for one of an L0 direction and an L1 direction. In other words, a prediction parameter may be derived by using a luma reference block in an L0 direction and a chroma reference block in an L0 direction or a prediction parameter may be derived by using a luma reference block in an L1 direction and a chroma reference block in an L1 direction.

In this case, which of an L0 direction and an L1 direction will be used may be predefined in an encoder and a decoder.

Alternatively, one of an L0 direction and an L1 direction may be selected by comparing a distance between a current picture and each of a reference picture in an L0 direction (i.e., an L0 reference picture) and a reference picture in an L1 direction (i.e., an L1 reference picture). Here, a distance represents the POC (Picture Order Count) difference between two pictures. As an example, a prediction parameter may be derived by using reference blocks in a direction closer to a current picture between an L0 reference picture and an L1 reference picture. In other words, when a distance between an L0 reference picture and a current picture is less than a distance between an L1 reference picture and a current picture, a prediction parameter may be derived by using a luma reference block in an L0 direction and a chroma reference block in an L0 direction.

Meanwhile, when a distance between an L0 reference picture and a current picture is the same as a distance between an L1 reference picture and a current picture, a prediction parameter may be derived by using weighted summed reference blocks.

Alternatively, when there is a picture designated as a Col picture among an L0 reference picture and an L1 reference picture, a prediction parameter may be derived by using only reference blocks derived from a reference picture designated as a Col picture.

Alternatively, a prediction parameter may be derived by using reference blocks in the same direction as a Col picture.

As another example, when bi-prediction is applied to a luma block, one of a plurality of prediction parameter candidates may be selected to predict a chroma block.

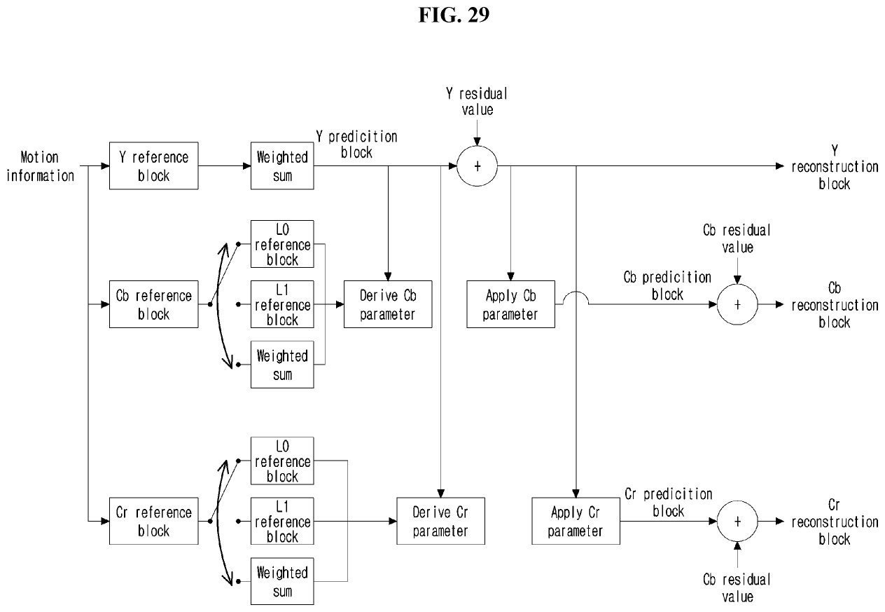

FIG. 29 illustrates an example in which a chroma block is predicted by selecting one of a plurality of prediction parameter candidates.

A plurality of prediction parameter candidates may include at least one of the first prediction parameter candidate derived by using reference blocks in an L0 direction, the second prediction parameter candidate derived by using reference blocks in an L1 direction or the third prediction parameter candidate derived by using a weighted-predicted reference block. The first prediction parameter candidate may be derived based on a correlation between the L0 reference block of a luma block and the L0 reference block of a chroma block, and the second prediction parameter candidate may be derived based on a correlation between the L1 reference block of a luma block and the L1 reference block of a chroma block. In addition, the third prediction parameter candidate may be derived based on a correlation between the weighted sum result of the L0 reference block and L1 reference block of a luma block and the weighted sum result of the L0 reference block and L1 reference block of a chroma block.

An encoder may select an optimal prediction parameter candidate among a plurality of prediction parameter candidates and predict a chroma block based on a selected prediction parameter candidate. In addition, an encoder may encode index information indicating an optimal prediction parameter candidate among a plurality of prediction parameter candidates and signal it to a decoder.

Meanwhile, the index information may be encoded and signaled for each of a Cb component and a Cr component. In other words, an optimal prediction parameter for a Cb component may be determined based on index information decoded for a Cb component among a plurality of prediction parameter candidates for a Cb component, and an optimal prediction parameter for a Cr component may be determined based on index information decoded for a Cr component among a plurality of prediction parameter candidates for a Cr component.

Alternatively, for Cb and Cr components, single index information may be encoded and signaled. As an example, when the index information indicates an L0 direction, for both Cb and Cr components, a prediction parameter may be derived based on reference blocks in an L0 direction.

Alternatively, when bi-prediction is applied to a luma block, a prediction parameter may be derived by using a chroma reference block for one of the L0 direction or L1 direction of a chroma block.

In other words, a prediction parameter may be derived by using the weighted summed reference block of a luma component (i.e., a block derived by weighted summing an L0 reference block and an L1 reference block) and a chroma reference block in an L0 direction or a prediction parameter may be derived by u sing the weighted summed reference block of a luma component and a chroma reference block in an L1 direction. It means that bi-prediction is applied to a luma prediction block, while uni-prediction is performed for a chroma block.

Meanwhile, whether to use a chroma reference block in an L0 direction or a chroma reference block in an L1 direction may be determined by a preset condition. Alternatively, information representing the prediction direction of a chroma block may be encoded and signaled. The prediction direction may indicate L0 uni-prediction, L1 uni-prediction or bi-prediction. According to the prediction direction, at least one of a chroma reference block in an L0 direction or a chroma reference block in an L1 direction may be selected.

As another example, for one of a Cb component and a Cr component, a prediction parameter may be derived by a correlation between a luma prediction block and a chroma reference block, and for the other of a Cb component and a Cr component, difference information with the prediction parameter may be encoded and signaled.

As an example, an encoder may derive a prediction parameter for a Cb component based on a correlation between a luma prediction block and the reference block of a Cb component. After determining the prediction parameter of a Cr component, difference information between the prediction parameter of a Cr component and the prediction parameter of a Cb component may be encoded and signaled.

In the same way as an encoder, a decoder may derive a prediction parameter for a Cb component based on a correlation between a luma prediction block and the reference block of a Cb component. After decoding difference information between the prediction parameter of a Cr component and the prediction parameter of a Cb component from a bitstream, the difference value may be added to the prediction parameter of a Cb component to derive a prediction parameter for a Cr component.

Meanwhile, the difference information may include at least one of a difference value between weights or a difference value between offsets.

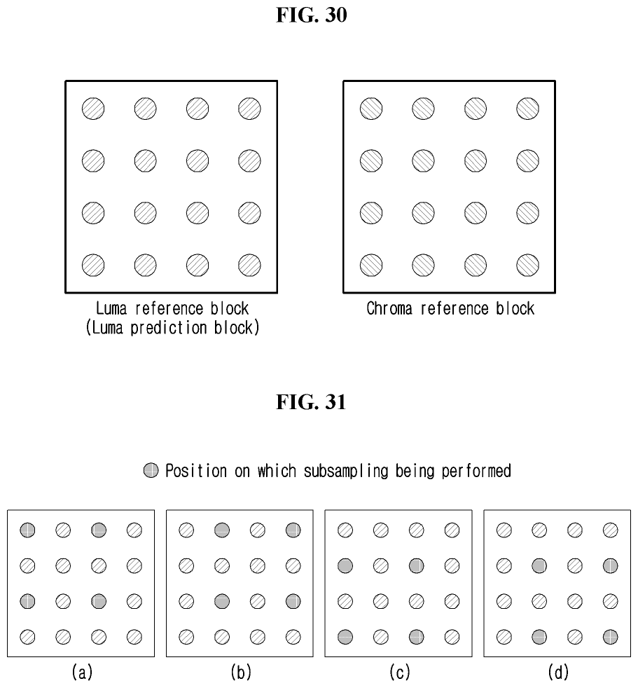

FIG. 30 represents an example in which a prediction parameter for a chroma component is derived.

For convenience of a description, it is assumed that a chroma format is 4:4:4 and the sizes of a luma prediction block and a reference block for a chroma component (i.e., a chroma reference block) are 4×4. Here, a chroma component may represent a Cb component or a Cr component.

To derive a prediction parameter for a chroma component, a difference (i.e., an error (E)) between samples within a luma prediction block and samples within a chroma reference block may be defined as in Equation 7 below.

E=Σ_{(i,j)∈T}{RefC[i][j]−(α×PredL[i][j]+3)}² [Equation 7]

In Equation 7 above, T represents a block, and (i,j) represents the coordinates of a sample within a block. RefC represents a sample value within a chroma reference block, and PredL represents a prediction sample value within a luma prediction block. When a chroma format is not 4:4:4, PredL may be obtained by applying a downsampling filter to prediction samples within a luma prediction block.

Afterwards, Equation 7 may be partially differentiated with weight u and offset B as shown in Equations 8 and 9, respectively, and weight u and offset B whose partial differentiation result becomes 0 may be derived.

∂E/∂α=0 [Equation 8]

∂E/∂β=0 [Equation 9]

When a prediction parameter is derived through the above-described process, a derived prediction parameter may be applied to a reconstructed luma block to obtain a prediction block for a chroma block. Equation 10 represents an example in which a prediction block for a chroma block is derived.

PredC[i][j]=α×recL[i][j]+β,(i,j)∈T [Equation 10]

In Equation 10, PredC represents the prediction sample of a chroma component, and recL represents a reconstructed sample within a reconstructed luma block. When a chroma format is not 4:4:4, recL may be obtained by applying a downsampling filter to reconstructed samples within a luma reconstructed block.

As in an example illustrated in Equation 10, the prediction sample of a chroma block may be obtained by multiplying a luma reconstructed sample at the same position as a position to be predicted within a chroma block by weight u and adding offset B to its resulting value.

Meanwhile, to simplify a process of deriving a prediction parameter, a prediction parameter may also be derived by using only samples at a subsampled position.

FIG. 31 represents a subsampled position.

A prediction block for a chroma block may be obtained by using only samples at a sub-sampled position within a luma prediction block and a chroma reference block.

Which of the subsampling position candidates illustrated in FIG. 31 will be used may be predefined in an encoder and a decoder.

Alternatively, index information indicating one of a plurality of subsampling position candidates may be encoded and signaled.

Alternatively, a plurality of prediction parameter candidates may be derived based on a plurality of subsampling position candidates. As an example, a prediction parameter candidate may be derived from each of the candidates illustrated in FIG. 31(a) to (d).

An encoder may determine an optimal prediction parameter among a plurality of prediction parameter candidates and encode and signal index information indicating an optimal prediction parameter among a plurality of prediction parameter candidates.

Alternatively, according to a chroma format, a subsampling position may be adaptively determined.

Alternatively, according to a chroma format, subsampling may be performed only on a luma prediction block.

In an example described above, it is illustrated that a prediction parameter includes weight a and offset J. As another example, a plurality of filter coefficients may be defined as a prediction parameter. As an example, the filter coefficients of a convolution filter that minimizes a difference between a luma prediction block and a chroma reference block may be defined as a prediction parameter.

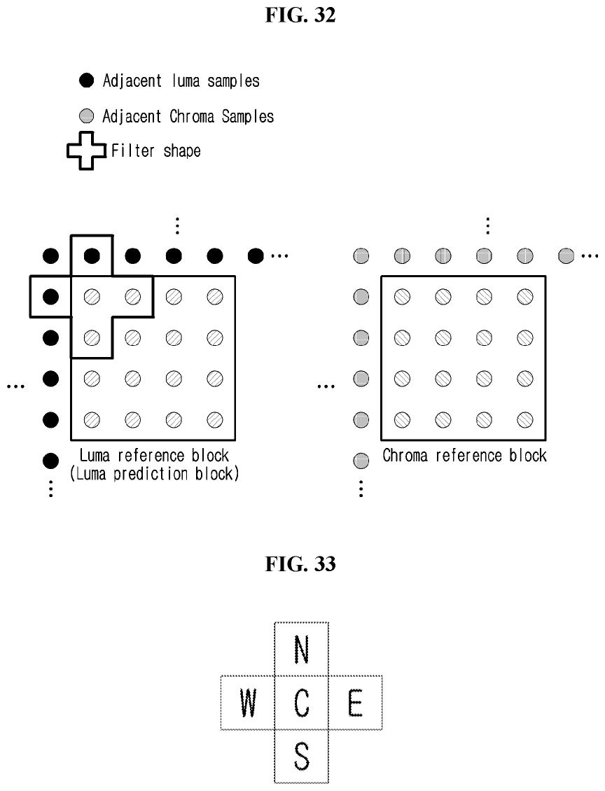

FIG. 32 represents an example in which a prediction parameter is derived by using a convolution filter. In addition, FIG. 33 represents the shape of a convolution filter.

FIG. 32 represents an example in which a prediction parameter is derived by using a 5-tap convolution filter illustrated in FIG. 33.

As in an example illustrated in FIG. 33, C represents a luma prediction sample positioned at the center of a filter, and N, W, S and E represent samples around a luma prediction sample. As an example, N may represent a sample neighboring the top of luma prediction sample C, i.e., a sample at the position of [i, j−1]. S may represent a sample neighboring the bottom of luma prediction sample C, i.e., a sample at the position of [i, j+1]. W may represent a sample neighboring the left of luma prediction sample C, i.e., a sample at the position of [i−1, j]. E may represent a sample neighboring the right of luma prediction sample C, i.e., a sample at the position of [i+1, j].

When a chroma format is not 4:4:4, a luma prediction block may be downsampled. In other words, C may represent a downsampled luma prediction sample. In addition, N, W, S and E may represent samples adjacent to the C within a downsampled luma prediction block.

Meanwhile, when a luma prediction sample is positioned at the boundary of a luma block, a sample outside a luma block must be input to a convolution filter. In this case, a sample input to a convolution filter may be a reconstructed sample around a luma block. In other words, [i, j] may represent coordinates within a luma block.

Alternatively, a sample input to a convolution filter may be a reconstructed sample around the reference block of a luma block within a reference picture. In other words, [i, j] may represent the coordinates of the reference block of a luma block within a reference picture.

By applying a convolution filter to a luma prediction block, the output value of a convolution filter may be obtained, and filter coefficients that minimize a difference (i.e., an error (E)) between the output value of a convolution filter and a sample value within a corresponding chroma reference block may be derived. As an example, Equation 11 represents an example in which filter coefficients are derived.

E=Σ_{(i,j)∈T}{RefC[i][j]−(w0×C+w1×N+w2×S+w3×E+w4×W+w5×B)}² [Equation 11]

In Equation 11, w0 to w4 represent a weight applied to C, N, S, E and W, respectively. RefC represents a sample within a chroma reference block.

B may be a value derived based on the bit depth of a picture. As an example, Equation 12 represents an example in which variable B is derived.

B=1<<(D−1) [Equation 12]

In Equation 12, D represents a bit depth. As an example, when a bit depth is 10 bits, B may be set as 512, which is the intermediate value of a range that may be expressed in 10 bits. Alternatively, when a bit depth is 8 bits, B may be set as 128, which is the intermediate value of a range that may be expressed in 8 bits.

Alternatively, variable B may be set as the average value of prediction samples within a luma prediction block. Alternatively, variable B may be set as the average value of samples input to a convolution filter. Alternatively, information representing the value of variable B may be explicitly encoded and signaled.

Afterwards, Equation 11 may partially differentiate each of the filter coefficients (i.e., w0 to w5) and derive a filter coefficient whose partial differentiation result becomes 0.

When filter coefficients are derived, a convolution filter may be applied to a luma block to obtain the prediction sample of a chroma block. As an example, the prediction sample of a chroma block may be derived by Equation 13 below.

PredC[i][j]=w0·C′+w1·N′+w2·S′+w3·E′+w4·W′+w5·B′,(i,j)∈T [Equation 13]

In Equation 13, PredC represents the prediction sample of a chroma block. C′ refers to a reconstructed sample (i.e., recL[i][j]) at the same position as a chroma prediction sample within a luma block. N′, S′, E′ and W′ represent samples adjacent to C′. As an example, N′ may represent the top adjacent sample of C′, and S′ may represent the bottom adjacent sample of C′. E′ may represent the right adjacent sample of C′, and W′ may represent the left adjacent sample of C′.

When a chroma format is not 4:4:4, a luma block may be downsampled. In other words, C′ may represent a downsampled luma reconstructed sample. In addition, N′, W′, S′ and E′ may represent samples adjacent to the C′ within a downsampled luma block.

Meanwhile, a filter shape is not limited to an illustrated example. As an example, a prediction parameter and a chroma prediction sample may be derived by using a 1D-shaped, square or rectangular filter.

In an example described above, a prediction parameter including weight u and offset B may be referred to as a linear prediction parameter, and a prediction parameter including the filter coefficients (e.g., w0 to w5) of a convolution filter may be referred to as a convolution prediction parameter.

In this case, information indicating which of a linear prediction parameter and a convolution prediction parameter will be used for the prediction of a chroma block may be encoded and signaled.

Alternatively, one of a linear prediction parameter and a convolution prediction parameter may be selected based on at least one of a chroma format, the size of a luma/chroma block, a bit depth, the average value of reconstructed samples within a luma block or a slice type. As an example, when a chroma format is 4:4:4, a chroma block may be predicted by using a linear prediction parameter. On the other hand, when a chroma format is 4:2:2 or 4:2:0, a chroma block may be predicted by using a convolution prediction parameter.

Alternatively, a linear prediction parameter and a convolution prediction parameter may be combined to obtain the prediction block of a chroma block. As an example, the first prediction block for a chroma block may be obtained based on a linear prediction parameter, and the second prediction block for a chroma block may be obtained based on a convolution prediction parameter. Afterwards, the final prediction block of a chroma block may be derived by averaging or weighted summing the first prediction block and the second prediction block.

Meanwhile, prediction between color components based on a prediction parameter may be performed in a sub-block unit.

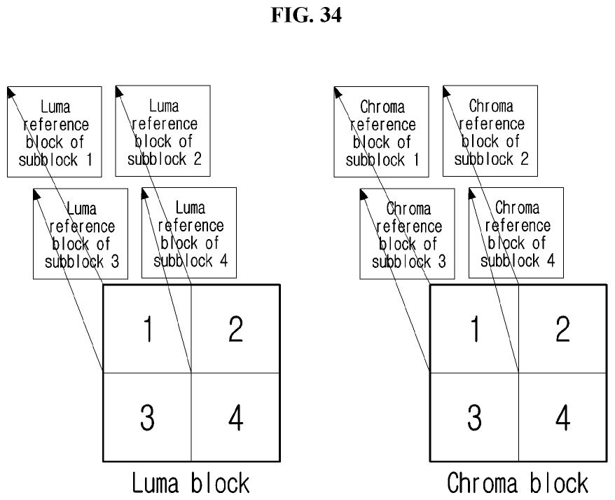

FIG. 34 is a diagram for describing an example in which a prediction method between color components based on a prediction parameter is performed in a sub-block unit.

A chroma block may be partitioned into a plurality of sub-blocks, and a prediction parameter may be independently derived for each chroma sub-block.

As an example, a reference block for the first luma sub-block may be determined based on the motion information of the first luma sub-block within a luma block. A reference block for the first luma sub-block may be the prediction block of the first luma sub-block.

In addition, a reference block may also be determined for the first chroma sub-block within a chroma block. The reference block of the first chroma sub-block may be a block at the same position as the reference block of the first luma sub-block within a reference picture.

Alternatively, the motion information of the first chroma sub-block may be derived from the motion information of the first luma sub-block, and the reference block of the first chroma sub-block may be derived based on the motion information of the first chroma block.

Afterwards, the first prediction parameter for the first chroma sub-block may be derived by using the reference block of the first luma sub-block and the reference block of the first chroma sub-block.

In the same manner as above, the second to fourth prediction parameters may be derived for the second to fourth chroma sub-blocks.

Afterwards, the prediction block of a chroma sub-block may be derived based on the prediction parameter of each chroma sub-block. As an example, a prediction block for the first chroma sub-block within a chroma block may be obtained by applying the first prediction parameter to the first luma sub-block within a luma block. In addition, a prediction block for the second chroma sub-block within a chroma block may be obtained by applying the second prediction parameter to the second luma sub-block within a luma block.

Similarly, a prediction block for the third chroma sub-block may be obtained by applying the third prediction parameter to the third luma sub-block, and a prediction block for the fourth chroma sub-block may be obtained by applying the fourth prediction parameter to the fourth luma sub-block.

The size of a sub-block may be predefined in an encoder and a decoder.

Alternatively, information representing the size of a sub-block may be encoded and signaled through a higher header.

Information representing whether prediction between color components based on a prediction parameter is performed in a sub-block unit may be encoded and signaled.

Alternatively, whether prediction between color components based on a prediction parameter is performed in a sub-block unit may be determined based on at least one of the size of a luma/chroma block, the number of samples included in a sub-block generated when a block is partitioned or a chroma format.

Alternatively, whether prediction between color components based on a prediction parameter is performed in a sub-block unit may be determined based on whether the inter prediction of a luma block is performed in a sub-block unit. As an example, when a luma block is encoded/decoded based on an affine model or SbTMVP, prediction between color components based on a prediction parameter may be performed in a sub-block unit. On the other hand, when a luma block is encoded/decoded based on a translation motion model, prediction between color components may be performed by deriving a prediction parameter at a block level.

Meanwhile, for a sub-block for which prediction parameter derivation is not available among the sub-blocks within a chroma block, a prediction parameter derived at a block level may be derived.

As an example, when a luma sub-block corresponding to a chroma sub-block is not encoded by inter prediction or when a motion vector stored in a luma sub-block does not exist, deriving a prediction parameter for the chroma sub-block may be unavailable.

In this case, a prediction parameter may be derived at a block level, and a derived prediction parameter at a block level may be used as the prediction parameter of a chroma sub-block. Here, a prediction parameter at a block level may be derived based on a correlation between the reference block of a luma block and the reference block of a chroma block.

Alternatively, when deriving a prediction parameter for a chroma sub-block is unavailable, the prediction parameter of an adjacent chroma sub-block may be set as the prediction parameter of the chroma sub-block. As an example, the prediction parameter of a neighbor chroma sub-block adjacent to the left or top of a chroma sub-block may be set as the prediction parameter of the chroma sub-block.

Information representing whether prediction between color components based on a prediction parameter is applied to a chroma block may be encoded and signaled. The information may be a 1-bit flag.

Meanwhile, prediction between color components based on a prediction parameter may be limitedly allowed when a predetermined condition is satisfied. Here, a predetermined condition may be determined based on at least one of the number of transformed and quantized coefficients, the values of transformed and quantized coefficients, the number of samples within a luma block, the value of a sample within a luma block, a chroma format or whether bi-prediction is performed. The transformed and quantized coefficients may also be referred to as a residual coefficient.

As an example, prediction between color components based on a prediction parameter may be performed when all transformed and quantized coefficients within a luma block are not 0.

Alternatively, prediction between color components based on a prediction parameter may be applied only when the number of non-zero transformed and quantized coefficients within a luma block is greater than or equal to a threshold value.

Alternatively, prediction between color components based on a prediction parameter may be performed only when the values of all samples within a luma block are not 0.

Alternatively, prediction between color components based on a prediction parameter may be performed only when the values of all residual samples within a luma block are not 0.

Alternatively, prediction between color components based on a prediction parameter may be performed only when at least one of an AMVP mode, a merge mode, template matching or bilateral matching is applied to a luma block.

Based on at least one of the conditions listed above, it may also be determined whether to derive a prediction parameter in a sub-block unit.

As an example, a prediction parameter may be derived for a chroma sub-block only when the values of all residual samples within a luma sub-block are not 0. If the value of at least one residual sample within a luma sub-block is 0 or if the values of all residual samples are 0, deriving a prediction parameter for a chroma sub-block may be unavailable.

When deriving a prediction parameter for a chroma sub-block is unavailable, a prediction parameter derived at a block level or the prediction parameter of a neighbor chroma sub-block may be set as the prediction parameter of the chroma sub-block.

Meanwhile, prediction between color components based on a prediction parameter may also be applied when an intra block copy mode is applied to a luma block. In this case, the reference block of a luma block and the reference block of a chroma block may exist in a pre-reconstructed region within a current picture.

The prediction parameter of a chroma block may be derived based on a correlation between a reference block within a current luma picture and a reference block within a current chroma picture.

When it is determined to apply prediction between color components to a chroma block, a reference region for deriving a prediction parameter may be set differently based on the encoding mode of a corresponding luma block.

As an example, when a luma block is encoded by inter prediction, the reference block of a luma block may be derived from a reference picture based on the motion information of a luma block, and the reference block of a chroma block may be derived from a reference picture based on the motion information of a chroma block. Afterwards, a prediction parameter may be derived based on a correlation between the reference block of a luma block and the reference block of a chroma block.

On the other hand, when a luma block is encoded by intra prediction, a prediction parameter may be derived based on a correlation between a template adjacent to a luma block and a template adjacent to a chroma block.

Applying embodiments described centering on a decoding process or an encoding process to an encoding process or a decoding process is included in the scope of the present disclosure. Changing embodiments described in predetermined order in different order than described is also included in the scope of the present disclosure.

The above-described disclosure is described based on a series of steps or flowcharts, but it does not limit the time-series order of the invention, and may be performed simultaneously or in different order, if necessary. In addition, each component (e.g., a unit, a module, etc.) configuring a block diagram in the above-described disclosure may be implemented as a hardware device or software, or a plurality of components may be combined and implemented as one hardware device or software. As an example, the hardware device may include at least one of a processor for performing an operation, a memory for storing data, a transmitter for transmitting data and a receiver for receiving data.

The above-described disclosure may be implemented in the form of a program instruction that may be executed by various computer components and recorded on a computer-readable recording medium. The computer-readable storage medium may include program instructions, data files, and data structures, either solely or in combination.

In addition, according to the present disclosure, a computer-readable recording medium for storing a bitstream generated by an encoding method described above may be provided. The bitstream may be transmitted by an encoding device, and a decoding device may receive the bitstream to decode an image.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. The hardware device may be configured to operate as at least one software module in order to perform processing according to the present disclosure, and vice versa.

### INDUSTRIAL APPLICABILITY

The present disclosure may be applied to a computing or electronic device that may encode/decode a video signal.

1. A method of decoding an image, the method comprising:
deriving a first reference block of a luma block at a co-located position of a chroma block;
deriving a second reference block of the chroma block;
deriving a prediction parameter based on the first reference block and the second reference block; and
applying the prediction parameter to the luma block to obtain a prediction block for the chroma block.

2. The method of claim 1, wherein when bi-prediction is applied to the luma block, the first reference block is obtained by weighted sum of an L0 reference block and an L1 reference block of the luma block, and
wherein the second reference block is obtained by weighted sum of an L0 reference block and an L1 reference block of the chroma block.

3. The method of claim 1, wherein when bi-prediction is applied to the luma block, the first reference block and the second reference block are determined based on a picture order count (POC) of an L0 reference picture and an L1 reference picture of the luma block.

4. The method of claim 3, wherein when a distance between the L0 reference picture and a current picture is smaller than a distance between the L1 reference picture and the current picture, each of the first reference block and the second reference block represents an L0 reference block of the luma block and an L0 reference block of the chroma block, and
wherein when the distance between the L1 reference picture and the current picture is smaller than the distance between the L0 reference picture and the current picture, the each of the first reference block and the second reference block represents an L1 reference block of the luma block and an L1 reference block of the chroma block.

5. The method of claim 4, wherein when the distance between the L0 reference picture and the current picture and the distance between the L1 reference picture and the current picture are equal, the first reference block is obtained by weighted sum of the L0 reference block and the L1 reference block of the luma block, and the second reference block is obtained by weighted sum of the L0 reference block and the L1 reference block of the chroma block.

6. The method of claim 1, wherein when bi-prediction is applied to the luma block, the first reference block and the second reference block are derived from at least one of a reference picture in an L0 direction or a reference picture in an L1 direction, and
wherein at least one of the L0 direction and the L1 direction is selected based on prediction direction information decoded from a bitstream.

7. The method of claim 1, wherein the prediction parameter includes a weight and an offset.

8. The method of claim 7, wherein a prediction sample of the chroma block is derived by adding the offset to a result obtained by multiplying a reconstructed sample, corresponding to a position of the prediction sample, in the luma block by the weight.

9. The method of claim 1, wherein the prediction parameter includes filter coefficients for a convolution filter.

10. The method of claim 9, wherein a prediction sample of the chroma block is derived by inputting a reconstructed sample, corresponding to a position of the prediction sample, in the luma block and at least one neighboring sample adjacent to the reconstructed sample into the convolution filter.

11. The method of claim 1, wherein a type of the prediction parameter is determined as one of a plurality of prediction parameter type candidates, and
wherein the plurality of prediction parameter type candidates include a first prediction parameter candidate including a weight and an offset and a second prediction parameter candidate including filter coefficients of a convolution filter.

12. The method of claim 1, wherein when an intra block copy mode is applied to the luma block, the first reference block is derived from a current luma picture including the luma block, and the second reference block is derived from a current chroma picture including the chroma block.

13. The method of claim 1, wherein the prediction parameter is derived in a sub-block unit within the chroma block.

14. A method of encoding an image, the method comprising:
deriving a first reference block of a luma block at a co-located position of a chroma block;
deriving a second reference block of the chroma block;
deriving a prediction parameter based on the first reference block and the second reference block; and
applying the prediction parameter to the luma block to obtain a prediction block for the chroma block.

15. A recording medium storing a bitstream generated by an image encoding method, the method comprising:
deriving a first reference block of a luma block at a co-located position of a chroma block;
deriving a second reference block of the chroma block;
deriving a prediction parameter based on the first reference block and the second reference block; and
applying the prediction parameter to the luma block to obtain a prediction block for the chroma block.
